(19) United States
(12) Patent Application Publication
(10) Pub. No.: US 2024/0382920 A1
(43) Pub. Date: Nov. 21, 2024

(54) SYSTEM FOR DECOUPLED CLR BASED SYNGAS PRODUCTION

(71) Applicant: Power Engineers, Incorporated, Meridian, ID (US)

(72) Inventor: Robert L. Krumm, Boise, ID (US)

(73) Assignee: Power Engineers, Incorporated, Meridian, ID (US)

(21) Appl. No.: 18/320,829

(22) Filed: May 19, 2023

(51) Int. Cl. B01J 8/18; B01J 8/00; B01J 8/26; B01J 8/42; C01B 3/44

(52) U.S. Cl. CPC B01J 8/1827; B01J 8/0055; B01J 8/007; B01J 8/26; B01J 8/42; C01B 3/44; C01B 2203/0233; C01B 2203/061; C01B 2203/062; C01B 2203/84

(57) ABSTRACT

A system for providing Closed Loop Reformation (CLR) based synthesis gas (syngas) production processes and systems where the metal oxidation and reduction systems are decoupled from the system and process thereby avoiding the closed and coupled loop metal oxidation and reduction systems used with prior art CLR based syngas production processes and systems, and the high temperature complexities associated with prior art CLR based syngas production processes and systems.

### BACKGROUND

A significant challenge facing the entire planet in the 21st century is the efficient generation of usable energy. One way in which this challenge can be addressed is the creation of usable energy in the form of synthesis gas or “syngas.”

Syngas is a mixture of hydrogen and carbon monoxide in various ratios. Syngas is an important component in the generation of such diverse products as hydrogen, ammonia, methanol, ethanol, other liquid fuels, electricity, and various chemicals and chemical compounds. In addition, syngas is itself combustible and therefore can be used as a fuel.

Historically, syngas has been used as a replacement for gasoline. As a notable historic example, syngas, in the form of wood gas, was used to power cars in Europe during WWII. In Germany alone half a million cars were built or rebuilt to run on syngas/wood gas.

Currently, the production of hydrogen (H₂) and other gas-to-liquid (GTL) products such as ammonia, methanol, and Fischer-Tropsch fuels rely on syngas availability and production. These products are of vital importance in the global chemical products market.

Traditionally, syngas is produced by steam reforming or partial oxidation of natural gas or liquid hydrocarbons, or coal gasification. In addition, biomass and related hydrocarbon feedstocks have been used to generate syngas and biochar in waste-to-energy gasification facilities. However, as discussed below, this is rarely done in traditional practice due to the complexities of making this conversion on an industrial scale.

Recently, chemical looping technologies such as Chemical Looping Reformation (CLR), have been employed in the production of syngas. Prior art CLR systems involve the use of gaseous carbonaceous feedstock and/or solid carbonaceous feedstock in the process of generating syngas in a closed and coupled chemical looping scheme. In particular, using CLR processes, the typical gaseous carbonaceous feedstocks used as liquid fuel are natural gas and reducing tail gas, while the typical solid carbonaceous feedstocks used as solids-based fuel are coal and biomass.

Typically, the feedstocks used with CLR systems are partially oxidized to generate syngas using metal oxides as the oxidant. The metal oxides are reduced in the process. Then using prior art CLR systems, the reduced metal oxides are oxidized in the regeneration step using air as part of a continuous, coupled, and closed loop. As discussed below, the fact that in the prior art the metal oxides are reduced and oxidized in a continuous closed loop, i.e., the entire system is a coupled and closed loop, presents several implementation issues, especially on a commercial scale.

The motivation for developing the CLR based syngas production processes lies in the fact that using the CLR based syngas production processes the need for, and use of, pure oxygen in the reaction is circumvented. Therefore, using CLR based syngas production processes, energy intensive air separation requirements associated with conventional gasification processes are avoided, and the syngas conversion efficiency is significantly increased.

Many CLR based syngas production processes also use steam and carbon dioxide as oxidants. Using CLR syngas production processes, the metal oxide also serves as a heat transfer medium in the chemical looping process. Consequently, using CLR syngas production processes, the efficiency of the reforming and gasification processes is significantly improved compared to the conventional processes.

Prior art CLR syngas production systems are typically of two general types, fluidized bed CLR syngas production systems and moving bed CLR syngas production systems. In general, prior art fluidized bed CLR syngas production systems use gas to transport the metal oxide components within the closed and coupled CLR oxidation/reduction loop while prior art moving bed CLR syngas production systems use mechanical mechanisms, such as augers, to transport the metal oxide components within the closed and coupled CLR oxidation/reduction loop.

FIG. 1A shows a block diagram of one specific and simplified example of a typical prior art fluidized bed CLR syngas production system 100. FIG. 1B shows a block diagram of one specific and simplified example of a typical prior art moving bed CLR syngas production system 150.

Referring to FIG. 1A, prior art fluidized bed CLR syngas production system 100 includes a closed and coupled solids loop consisting of: closed solids loop segment 111 where reduced metal 133 from metal reducing reactor 103 is fed to metal oxidizing reactor 101 and air or oxygen 107 is provided to reduced metal 133 and metal oxidizing reactor 101 to transform reduced metal 133 to oxidized metal 102; closed solids loop segment 112 where the reduced metal 133 is passed through metal oxidizing reactor 101 and converted to oxidized metal 102 by metal oxidizing reactor 101 and air or oxygen 107; closed solids loop segment 113 where oxidizer exhaust 141 is separated from the oxidized metal 102 by a solid/gas separator 140, such as a cyclone, or other mechanism, for separating off oxidizer exhaust 141; closed solids loop segment 114 where oxidized metal 102 is fed back to the metal reducing reactor 103 and which also receives fuel and/or steam 105 and where oxidized metal 102 is converted back to reduced metal 133; closed fluid processing segment 123 from high temperature zone 106 of metal reducing reactor 103 to solid/gas separator 145 where any remaining solids are filtered/separated from the reducing reactor exhaust 147, e.g., the syngas, and the removed solids are then fed back into the metal reducing reactor 103 via separated closed solids loop segment 125 that feeds the removed solids into closed solids loop segment 111. The reduced metal 133 is then returned to closed solids loop segment 111 at which point the closed solids loop consisting of closed solids loop segments 111, 112, 113, 114, and 125 is complete. The oxidation/reduction loop then repeats in a closed continuous cycle consisting of closed solids loop segments 111, 112, 113, 114, and 125.

As also seen in FIG. 1A, prior art fluidized bed CLR syngas production system 100 also includes fluid processing segment 121 from low temperature zone 104 of metal reducing reactor 103 to high temperature zone 106 of metal reducing reactor 103; fluid processing segment 123 from high temperature zone 106 of metal reducing reactor 103 to solid/gas separator 145 where any remaining solids are filtered/separated from the reducing reactor exhaust 147, e.g., the syngas, and where the removed solids are then fed back into the metal reducing reactor 103 via closed solids loop segment 125.

Of particular note is the fact that, in the prior art, the metal oxides are reduced and oxidized in a continuous closed loop consisting of closed solids loop segments 111, 112, 113, 114, and 125. One result of these prior art closed solids loop systems is that the oxidized metal 102 provided by metal oxidizing reactor 101 is extremely hot, around 1,100 degrees Celsius. This creates several operation, equipment, and safety issues discussed in more detail below.

Of note, the flow through metal oxidizing reactor 101 and metal reducing reactor 103 is in the same direction, i.e., in the direction 149, which is also the direction of increasing temperature through metal oxidizing reactor 101 and metal reducing reactor 103. Also, as noted above, using prior art fluidized bed CLR syngas production system 100 the metal oxides are reduced and oxidized in a continuous closed loop consisting of closed solids loop segments 111, 112, 113, 114, and 125. As also noted above, one result of this prior art closed solids loop system is that the oxidized metal 102 from metal oxidizing reactor 101 is extremely hot, around 1,100 degrees Celsius.

In addition, as shown in FIG. 1A, using prior art fluidized bed CLR syngas production system 100 the entire system is a coupled and closed loop. Consequently, in the prior art, the same solid metal oxide is reduced to reduced metal 133 and oxidized/re-oxidized to oxidized metal 102 as it moves between the two reactors, i.e., oxidizing reactor 101 and metal reducing reactor 103. Thus, the metal oxidizing reactor 101 and metal reducing reactor 103 are connected in a closed solids circulatory loop.

FIG. 1B shows a simplified block diagram of a prior art moving bed CLR syngas production system 150. Referring to FIG. 1B, prior art moving bed CLR syngas production system 150 includes a closed and coupled solids loop or path consisting of closed solids loop segment 161 where reduced metal 133 is fed from metal reducing reactor 153 to metal oxidizing reactor 151 and air or oxygen 157 is provided to metal oxidizing reactor 151; closed solids loop segment 162 through metal oxidizing reactor 151 where reduced metal 133 is converted to oxidized metal 102 by metal oxidizing reactor 151 and air or oxygen 157; closed solids loop segment 163 where oxidizer exhaust 171 is separated from oxidized metal 102; and closed solids loop segment 164 where oxidized metal 102 is fed to metal reducing reactor 153 which also receives fuel and/or steam 155 and where oxidized metal 102 is reduced back to reduced metal 133 and reduced metal 133 is fed back to metal oxidizing reactor 151 via closed solids loop segment 161. The oxidation and reduction of the metal oxides is then continuously cycled via closed solids loop segments 161, 162, 163, and 164 as the same metal oxides are passed between metal reducing reactor 153 and metal oxidizing reactor 151.

Also seen in FIG. 1B are liquid processing segment 171 from low temperature zone 154 of metal reducing reactor 153 to high temperature zone 156 of metal reducing reactor 153 and liquid processing segment 173 from metal reducing reactor 153 to reducing reactor exhaust 177. As seen in FIG. 1B, as a result of the processes of low temperature zone 154 and temperature zone 156, syngas is produced by metal reducing reactor 153 and separated as reducing reactor exhaust 177.

As with fluidized beds systems, such as prior art fluidized bed CLR syngas production system 100 discussed above, using prior art moving bed CLR syngas production system 150 of FIG. 1B the same metal oxides, in the form of reduced metal 133 and oxidized metal 102, are reduced and oxidized in a continuous closed loop consisting of closed solids loop segments 161, 162, 163, 164. As noted above, one unfortunate result of this prior art closed solids loop system is that the oxidized metal 102 that is produced by metal oxidizing reactor 151 is extremely hot, around 1,100 degrees Celsius. Again, this creates several operation and safety issues discussed in more detail below.

Of note, in contrast to prior art fluidized bed CLR syngas production system 100, using prior art moving bed CLR syngas production system 150, the flow through metal oxidizing reactor 151 is in the direction 168, which is also in the direction of increasing temperature in metal oxidizing reactor 151, while the flow through metal reducing reactor 153 is in the opposite direction, i.e., in the direction of 149, which is also in the direction of increasing temperature through metal reducing reactor 153. Also, as noted above, using prior art moving bed CLR syngas production system 150, the metal oxides are reduced and oxidized in a continuous closed loop consisting of closed solids loop segments 161, 162, 163, 164 so that the entire system is a coupled and closed loop. Consequently, in the prior art, the same solid metal oxide is continuously circulated between the two reactors and is continuously transformed from oxidized metal 102 to reduced metal 133 in a closed loop. That is to say the metal oxidizing reactor 151 and metal reducing reactor 153 are connected in a closed solids circulatory loop.

Using both prior art fluidized bed CLR syngas production system 100 and prior art moving bed CLR syngas production system 150 oxidized metal 102 is used as the oxygen carrier. In one reactor, in the metal reducing reactor or fuel reactor, i.e., metal reducing reactors 103 and 153, the carbonaceous feedstock, i.e., fuel 105 or 155, is partially oxidized to syngas 147 or 177, while the oxidized metals 102 are reduced to a lower oxidation state, i.e., are reduced to reduced metal 133. One example of this process is given by:

CHₐO_{b}+1-b/ [symbol] MeOₓ→CO+a/ [symbol] H₂+1−b/ [symbol] MeO_{x-δ}

Where Me is a metal, typically a transition metal such as iron or nickel.

In another reactor, termed the metal oxidizing reactor, or air reactor (when air is used as the regeneration agent), i.e., metal oxidizing reactors 101 or 151, the reduced metal oxide, i.e., reduced metal 133, from the metal oxidizing reactor is re-oxidized by air or steam as follows:

2/δMeO_{x-δ}+O₂(air)→2/δMeOₓ+(O₂ depleted air)

1/δMeO_{x-δ}+H₂O→1/δMeOₓ+H₂

Again, of particular note is the fact that in the prior art, the same metal oxides are reduced to form reduced metal 133 and oxidized to form oxidized metal 102 and then reduced to reform reduced metal 133 then oxidized back to oxidized metal 102 in a continuous closed loop, i.e., the entire system is a coupled and closed loop. Consequently, in the prior art, the metal oxide is circulated between the two reactors, i.e., metal oxidizing reactors 101/151 and metal reducing reactor 103/153 so the two reactors, i.e., metal oxidizing reactors 101/151 and metal reducing reactor 103/153 are connected in a solids circulatory loop, while the gaseous reactants and products from each of the two reactors are isolated.

While CLR based syngas production processes, such as fluidized bed CLR syngas production system 100 and prior art moving bed CLR syngas production system 150, show real potential for providing a pathway to sustainable syngas production, complexities with the process and the physical limitations of the metal oxide oxygen carriers have hindered the wide spread acceptance and commercialization of CLR syngas production systems.

First, as noted above, using the prior art CLR based syngas production processes and systems, the metal oxides are reduced and oxidized in a continuous closed loop, i.e., the entire system is a coupled and closed loop. Consequently, using the prior art CLR based syngas production processes and systems the same metal oxide is continuously circulated between the two reactors, i.e., metal oxidizing reactors 101/151 and metal reducing reactor 103/153.

As also noted above, these closed and coupled loop systems taught in the prior art results in the continuously recycled oxidized metal and the oxidized metal 102 from metal oxidizing reactors 101/151 in FIGS. 1A and 1B is extremely hot, around 1,100 degrees Celsius. This creates several operation and safety issues.

First the temperatures of the oxidized metal is a safety issue for workers who must process, and be generally working around, the extremely hot oxidized metal and system oxidation components. Additionally, the system oxidation components that are part of the oxidized metal processing are also subject to more significant stresses and operational failure due to the high temperatures of the metal oxidation process and oxidized metal itself. This potentially results in more worker injuries and system failures, as well as less desirable working conditions and system down time for repairs and replacements.

In addition, at the temperatures of the oxidized metal used in prior art CLR based syngas production processes and systems, the metal oxides themselves are subject to several heat related failures and issues including, but not limited to, deformation, sintering, plugging of transfer mechanisms and pipes, fouling, and erosion. This again degrades system performance, increases system down-time and results in less efficient conversion and collection of the resulting syngas.

Further, by using the closed and coupled loop systems taught in the prior art CLR based syngas production processes and systems there can be time delays as the system waits for the same metal oxides to be oxidized and provided to the metal reducing reactor where the syngas is created.

In summary, while CLR based syngas production processes and systems have the potential to provide a pathway to sustainable syngas production, the closed and coupled loop metal oxidation and reduction systems used with prior art CLR based syngas production processes and systems, and the high temperature complexities associated with prior art CLR based syngas production processes and systems, have prevented prior art CLR based syngas production processes and systems from being widely adopted and commercialized. Consequently, prior art CLR based syngas production processes and systems have not yet lived up to the potential of CLR based syngas production. Given the world-wide need for the efficient and sustainable generation of usable energy, including syngas, this is an unfortunate situation.

What is needed is a method and system for producing syngas utilizing CLR based syngas production processes and systems that does not suffer from the drawbacks associated with prior art, including the closed and coupled loop metal oxidation and reduction systems discussed above.

### SUMMARY

Embodiments of the present disclosure provide a solution to the long-standing technical problem of providing methods and systems for producing syngas using CLR based syngas production processes and systems that do not suffer from the drawbacks associated with prior art closed and coupled loop metal oxidation and reduction systems.

To this end, disclosed herein are CLR based syngas production processes and systems where the metal oxidation and reduction sub-systems are decoupled from the CLR based syngas production processes and systems; thereby avoiding the closed and coupled loop metal oxidation and reduction requirement of prior art CLR based syngas production processes and systems, and the high temperature complexities associated with prior art CLR based syngas production processes and systems.

In one embodiment, using the disclosed decoupled CLR based syngas production processes and systems oxidized metal is fed directly to a low temperature reducer along with, in some embodiments, oxygen, and/or steam. Of note, using the disclosed embodiments, the oxidized metal can be from any source, including sources outside the disclosed decoupled CLR based syngas production processes and systems, i.e., using the disclosed decoupled CLR based syngas production processes and systems there is no closed oxidation and reduction loop and the oxidized metal from any source is provided directly to the low temperature reducer.

In one embodiment, the low temperature reducer is also provided heat from an external heat source so that the temperature of the reduction reactions can be controlled to avoid high temperature related issues such as deformation, sintering, plugging of transfer mechanisms and pipes, fouling, and erosion associated with the high temperature oxidized metal generated using prior art closed loop CLR based syngas production processes and systems.

In one embodiment, fuel, such as organic material, in solid or fluid form, is also provided to the low temperature reducer along with the oxidized metal.

In one embodiment, the output of the low temperature reducer, both solids and vapors, is fed to a solid/gas separator, such as a cyclone, gravity system, or filter. In one embodiment, at the solid/gas separator, solids from the low temperature reduction process of the low temperature reducer, such as reduced metal, ash and carbon biochar, and metal sulfides, are separated from the resultant vapor from the low temperature reduction process of the low temperature reducer.

In one embodiment, the separated vapor from the low temperature reducer is then fed to a high temperature reformer. In one embodiment, air and/or oxygen, and/or steam is also fed into the high temperature reformer. In one embodiment, the high temperature reformer converts the vapor from the low temperature reducer into syngas.

In one embodiment, the syngas from the high temperature reformer is then sent to a gas treatment station where the syngas is converted into various products such as but not limited to, hydrogen, methanol, ethanol, electricity, various chemicals, and the like.

In one embodiment, the solids from the low temperature reducer are fed to a solid separator where the solids are further separated into ash/carbon/biochar solids and reduced metal.

In one embodiment, the reduced metal is stored on site for future use and/or sale.

In one embodiment, the reduced metal is further separated into reduced metal and reduced metal sulfides by a sulfide separator.

In one embodiment, the reduced metal sulfides are then fed to a sulfur treatment station where the sulfur component is removed to generate reduced metal and elemental sulfur.

In some embodiments, the resulting ash/carbon/biochar solids and/or elemental sulfur is then used for various purposes including, but not limited to, organic soil amendments and/or various chemical compound production.

According to the disclosed embodiments, the metal oxidation and reduction processes are decoupled from the CLR based syngas production processes and systems; thereby avoiding the closed and coupled loop metal oxidation and reduction systems used with prior art CLR based syngas production processes and systems, and the high temperature complexities associated with prior art CLR based syngas production processes and systems.

Consequently, using the disclosed embodiments, and in direct contrast to prior art systems and teaching, the metal oxides are not reduced and oxidized in a continuous closed loop that is part of the overall CLR based syngas production processes and systems, i.e., the entire system need not be coupled to, and/or include, a closed solids loop. Thus, using the disclosed embodiments, the same metal oxides need not circulate between metal oxidizing reactors and metal reducing reactors. Therefore, there is no requirement for the metal oxidizing reactors and metal reducing reactors to be connected and there is no requirement for a closed solids circulatory loop.

Consequently, using the disclosed decoupled CLR based syngas production processes and systems the complexities with the prior art systems and processes, the physical limitations of the metal-oxide oxygen carrier loop, and the barriers to widespread commercialization of CLR based syngas production processes and systems are removed. This allows the potential of CLR based syngas production processes and systems for providing sustainable syngas to be achieved.

In addition, since the disclosed decoupled CLR based syngas production processes and systems do not require that the metal oxides be reduced and oxidized in a continuous closed loop that is part of the overall CLR loop, several operational and safety issues associated with prior art processes and systems are avoided.

First, since using the disclosed decoupled CLR based syngas production processes and systems the oxidized metal can be provided from sources external to the system, and/or be temporally and/or physically distanced from the disclosed decoupled CLR based syngas production processes and systems. Therefore, using the disclosed decoupled CLR based syngas production processes and systems temperatures of the oxidized metal can be virtually any temperature desired. This is in contrast to the 1,100 degree Celsius temperatures of the oxidized metals used in the prior art systems.

Consequently, the prior art safety issues for workers who must process and be generally around the oxidized metal and oxidation components are removed. In addition, using the disclosed decoupled CLR based syngas production processes and systems, the system components themselves are not subject to more significant stresses and operational failure rates associated with processing high temperature oxidized metal. This potentially results in fewer worker injuries and system failures, as well as more desirable working conditions and less system down time using the disclosed decoupled CLR based syngas production processes and systems.

In addition, using the disclosed decoupled CLR based syngas production processes and systems, the ability to use lower temperature oxidized metal avoids heat related failures and issues including, but not limited to deformation, sintering, plugging of transfer mechanisms and pipes, fouling, and erosion. This again increases system performance, decreases system down-time and results in more efficient conversion and collection of the resulting syngas.

In addition, by eliminating the closed and coupled loop systems taught in the prior art, the disclosed decoupled CLR based syngas production processes and systems avoid the time delays associated with prior art CLR based syngas production processes and systems which require that the same metals to be oxidized and provided to the metal reducing reactor where the syngas is created.

Further, using the disclosed decoupled CLR based syngas production processes and systems, the oxidized metal provided has a catalytic effect on the reactions taking place in the low temperature reducer and provide for improved heat transfer due to metal oxide particle disbursement. In addition, as discussed in more detail below, in various embodiments, sulfur species such as H₂S in the resultant syngas are reduced thru the formation and separation/removal of metal sulfides and elemental sulfur.

For these and numerous other reasons discussed herein, the disclosed decoupled CLR based syngas production processes and systems represent a significant improvement over the prior art methods and systems and provide a solution to the long-standing technical problem of providing methods and systems for producing syngas using CLR based syngas production processes and systems that do not suffer from the drawbacks associated with prior art closed and coupled loop metal oxidation and reduction systems.

### BRIEF DESCRIPTION OF THE DRAWINGS

FIG. 1A is a block diagram of one specific and simplified example of a typical prior art fluidized bed CLR syngas production system.

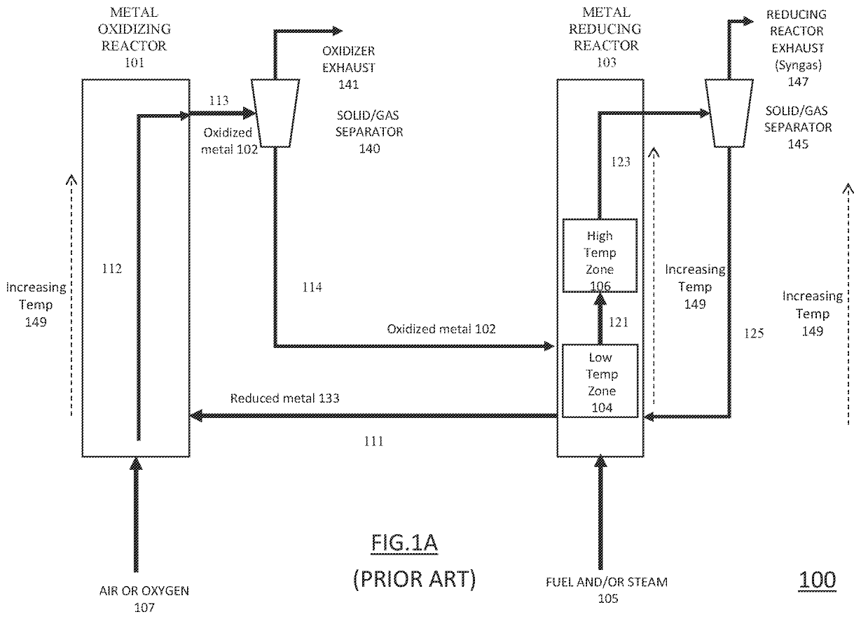

FIG. 1B is a block diagram of one specific and simplified example of a typical prior art moving bed CLR syngas production system.

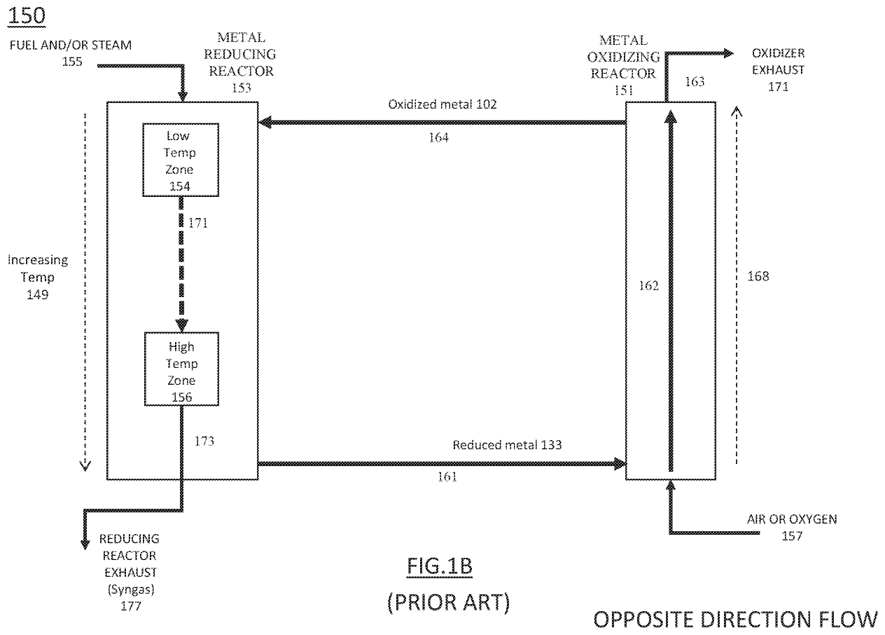

FIG. 2A is a block diagram of a decoupled CLR based syngas production system in accordance with one embodiment.

FIG. 2B is a block diagram of a decoupled CLR based syngas production system including solids separation into biochar production and reduced metal in accordance with one embodiment.

FIG. 2C is a block diagram of a decoupled CLR based syngas production system including solids separation into biochar production and reduced metal and metal sulfide separation in accordance with one embodiment.

FIG. 2D is a block diagram of one embodiment of a decoupled CLR based syngas production system including solids separation into biochar production and reduced metal, sulfide separation, and sulfur treatment in accordance with one embodiment.

FIG. 2E is a block diagram of one embodiment of a decoupled CLR based syngas production system including solids separation into biochar production and reduced metal and metal oxidation in accordance with one embodiment.

FIG. 2F is a block diagram of a decoupled CLR based syngas production system including solids separation into biochar production and reduced metal, sulfide separation, sulfur treatment, and metal oxidation in accordance with one embodiment.

FIG. 2G is a block diagram of a decoupled CLR based syngas production system including solids separation into biochar production and reduced metal, metal oxidation, and an oxidized metal feed into the low temperature reducer in accordance with one embodiment.

FIG. 2H is a block diagram of a decoupled CLR based syngas production system including solids separation into biochar production and reduced metal, sulfide and sulfur treatment, metal oxidation, and an oxidized metal feed into the low temperature reducer in accordance with one embodiment.

FIG. 3 is a simplified flow chart of the some of the operations of the disclosed decoupled CLR based syngas production processes in accordance with one embodiment.

Common reference numerals are used throughout the figures (FIGS.) and the detailed description to indicate like elements. One skilled in the art will readily recognize the above FIGS. are examples and that other processes, modes of operation, orders of operation, and elements/functions can be provided and implemented without departing from the characteristics and features of the invention, as set forth in the claims.

### DETAILED DESCRIPTION

Embodiments will now be discussed with reference to the accompanying figures (FIGS.), which depict one or more exemplary embodiments. Embodiments may be implemented in many different forms and should not be construed as limited to the embodiments set forth herein, shown in the FIGS., or described below. Rather, these exemplary embodiments are provided to allow a complete disclosure that conveys the principles of the invention, as set forth in the claims, to those of skill in the art.

Embodiments of the present disclosure provide a solution to the long-standing technical problem of providing methods and systems for producing syngas using CLR based syngas production processes and systems that do not suffer from the drawbacks associated with prior art closed and coupled loop metal oxidation and reduction systems.

To this end, disclosed herein are CLR based syngas production processes and systems where the metal oxidation and reduction systems are decoupled. Thus, using the disclosed decoupled CLR based syngas production processes and systems the drawbacks of prior art CLR based syngas production processes and systems that rely on closed and coupled loop metal oxidation and reduction systems, including the high temperature complexities associated with prior art CLR based syngas production processes and systems, are avoided.

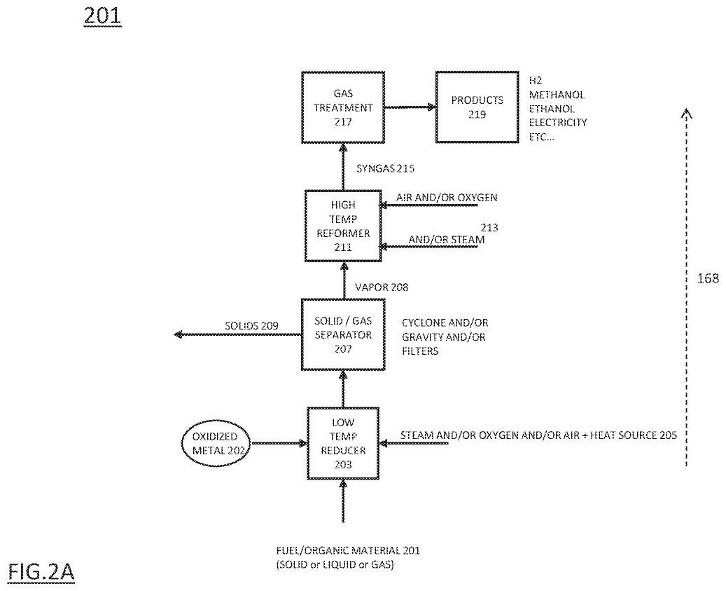

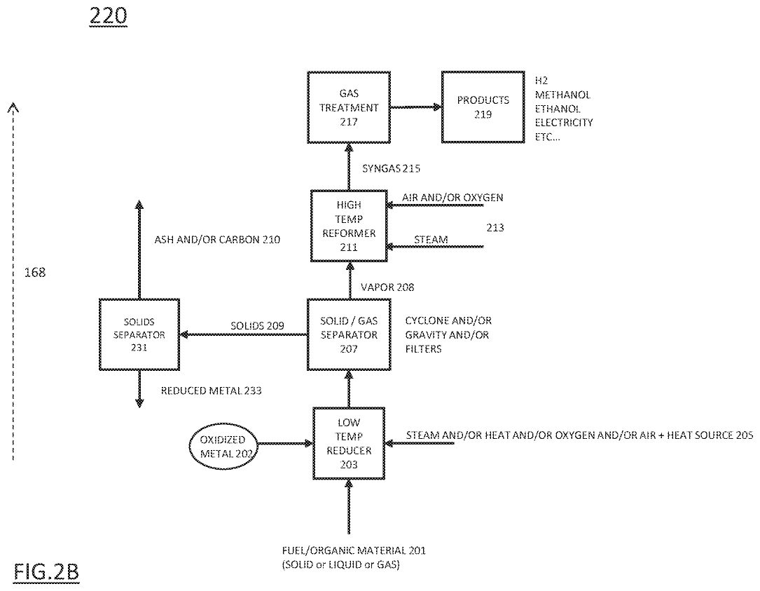

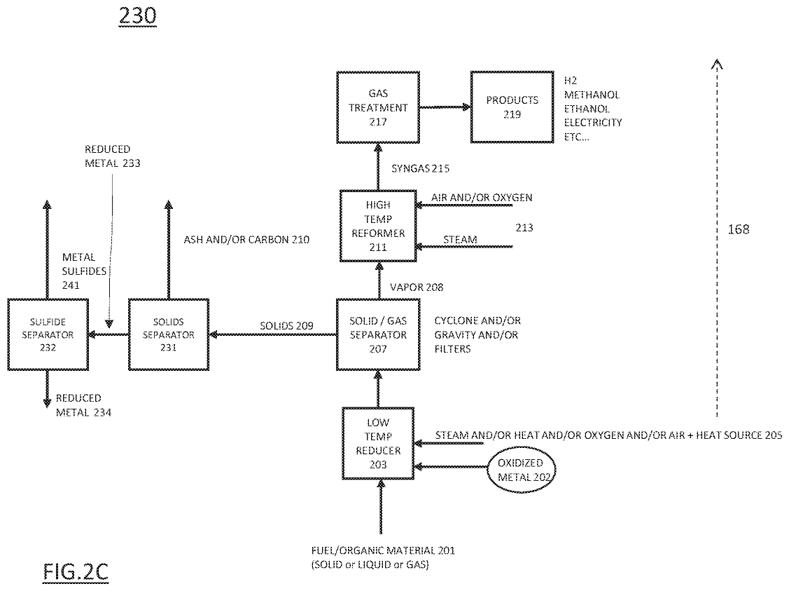

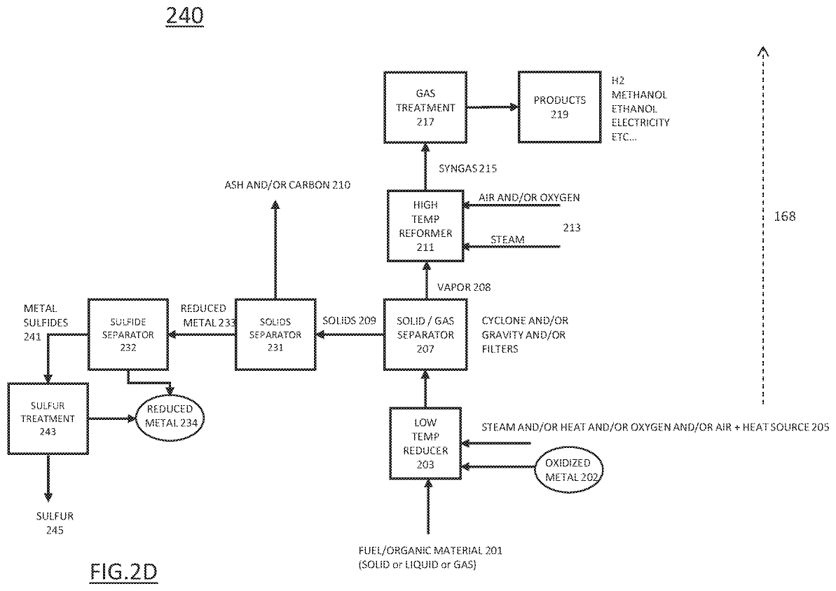

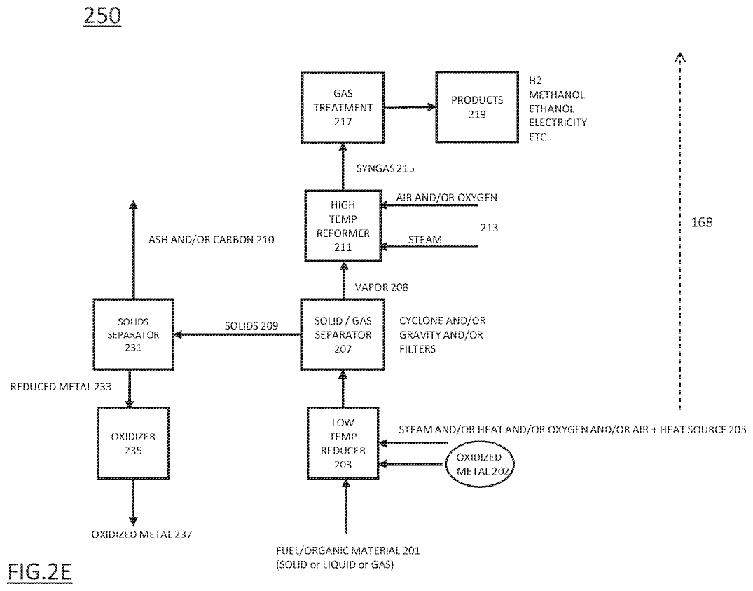

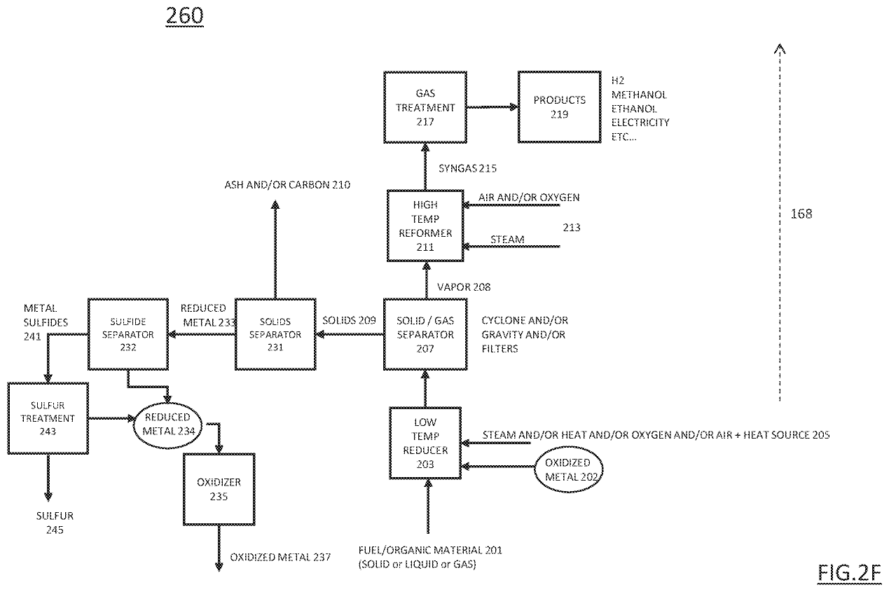

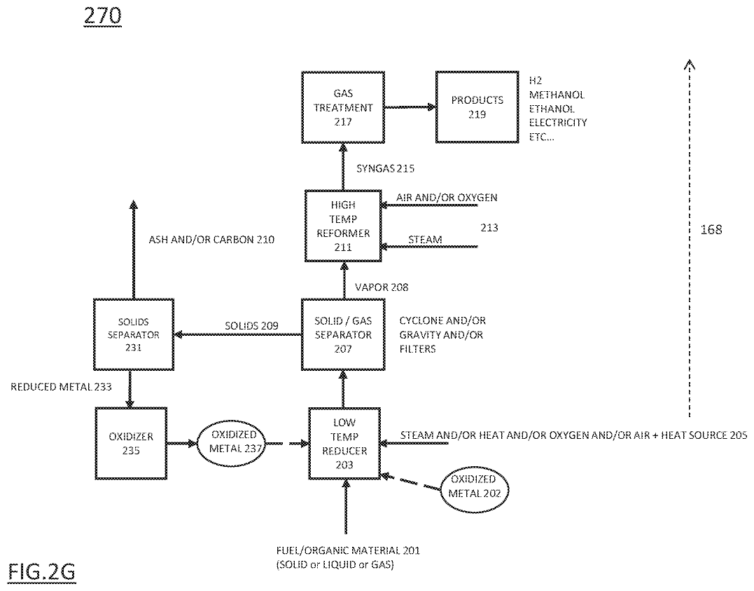

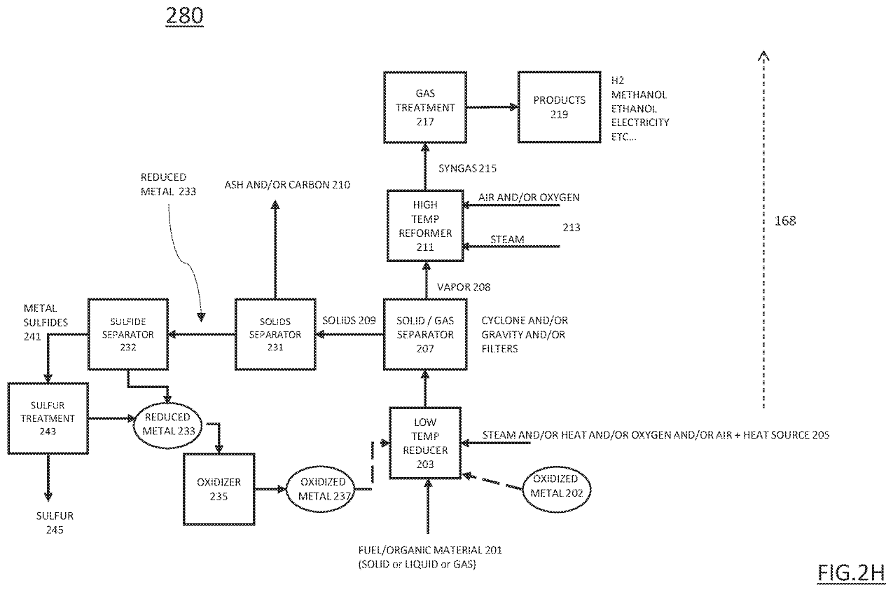

FIG. 2A is a block diagram of one embodiment of a decoupled CLR based syngas production system 201.

As seen in FIG. 2A, decoupled CLR based syngas production system 201 includes low temperature reducer 203, solid/gas separator 207, high temperature reformer 211, gas treatment station 217, and products 219.

As seen in FIG. 2A, in one embodiment, oxidized metal 202 is provided to low temperature reducer 203. Of particular note, the oxidized metal 202 can be from any source, including sources outside the decoupled CLR based syngas production system 201. This is in direct contrast to prior art CLR based syngas production processes and systems that require that the same metal oxides be reduced and oxidized in a continuous closed loop that is part of the overall CLR loop. Thus, using the disclosed embodiments, and in direct contrast to the prior art, the oxidized metal 202 need not come from within decoupled CLR based syngas production system 201. Consequently, using decoupled CLR based syngas production system 201, and in contrast to prior art teachings, oxidized metal 202 can be created and/or obtained from processes performed at a different location or performed at a different time, i.e., oxidation of oxidized metal 202 need not to performed either on-site or in real time. One advantage of this configuration is that the oxidized metal 202 can be lower temperature, in fact oxidized metal 202 can be provided at any temperature desired. This is in contrast to the prior systems where the oxidized metal is provided from within the system and in virtually real time and is therefore typically very high temperature, such as the 1,100 degree Celsius.

In specific illustrative examples, oxidized metal 202 can be any oxidized form of virtually any metal, including, but not limited to iron, nickel, aluminum, tungsten, titanium, tin, copper, manganese, magnesium, cerium, molybdenum, or combinations thereof or any other metal or mixture of metals capable of being oxidized and reduced and providing oxygen as discussed herein, and or as known in the art at the time of filing, and/or as developed/made available after the time of filing.

In some embodiments, oxidized metal 202 is in the form of a coating on a substrate material (not shown). In various embodiments, the substrate material can be, but is not limited to, Al₂O₃, CaAl₂O₄, TiO₂, ZrO₂, carbon, silica, zeolites, silicon nitride, aluminum nitride, silicon carbide, cordierite, alumina-silicate (e.g., mullite, illite, kaolinite), steatite, YSZ ceramic, and SiAlON ceramic or any combination thereof. However, in some embodiments, the substrate material can be any material as discussed herein, and or as known in the art at the time of filing, and/or as developed/made available after the time of filing capable of providing a substrate for metal oxides.

As seen in FIG. 2A, fuel 201, in the form of liquid or solid organic material, is also provided to low temperature reducer 203. In various embodiments, fuel 201 can be any organic material, in either a solid or fluid form, such as, but not limited to natural gas, landfill gas, petroleum gas, liquid petroleum, biomass, domestic and industrial refuse, refuse derived fuel, sewage, black liquor, coal, coke, animal waste, tar, oil shale, or any other source of carbon containing material.

In one embodiment, fuel 201 can be Refuse-Derived Fuel (RDF). RDF is a fuel produced from various types of waste such as municipal solid waste (MSW), industrial waste, or commercial waste.

As seen in FIG. 2A, in one embodiment, other sources of oxygen and/or heat 205 can optionally be provided to low temperature reducer 203. In various embodiments, the sources of oxygen can include steam, water, chemical oxidants (H₂O₂) and/or elemental oxygen, or any other source of oxygen as discussed herein, and or as known in the art at the time of filing, and/or as developed/made available after the time of filing.

In one embodiment, low temperature reducer 203 is optionally provided supplementary heat from an external heat source, such as an electric heating element. In these embodiments, the temperature of the reduction reactions taking place in low temperature reducer 203 can be controlled to increase efficiency and/or avoid high temperature related issues such as deformation, sintering, plugging of transfer mechanisms and pipes, fouling, and erosion.

In one embodiment, the reactions taking place in low temperature reducer 203 include the thermal decomposition of materials at elevated temperature to effect a change of chemical composition of the fuel 201.

In one embodiment, the reactions taking place in low temperature reducer 203 convert fuel 201. In one embodiment, the reactions fuel 201 is subjected to in low temperature reducer 203 are part of the processes involved in breaking carbon bonds. In general, the reduction reactions taking place in low temperature reducer 203 produces volatile products, i.e., vapor 208, and leaves biochar, a carbon-rich solid residue, carbon, and various other organic solids. The reduction reactions taking place in low temperature reducer 203 are the first step in the processes of producing syngas.

The general operation and structure of low temperature reducers, such as low temperature reducer 203, are well known in the art. Consequently, a more detailed discussion of any specific example of low temperature reducer 203 is omitted here to avoid detracting from the invention. In various embodiments, low temperature reducer 203 can be any low temperature reducer capable of supporting low temperature reduction reactions as discussed herein, and or as known in the art at the time of filing, and/or as developed/made available after the time of filing.

As seen in FIG. 2A, in one embodiment, the output of the low temperature reducer 203, e.g., both solids 209 and vapor 208, are fed to solid/gas separator 207. In one embodiment, at solid/gas separator 207 the solids 209 from low temperature reducer 203 are separated from the vapor 208 created in the reduction process of low temperature reducer 203.

In one embodiment, the solids 209 from low temperature reducer 203 include, reduced metal oxides, metal sulfides, ash, charcoal/biochar, and other solid-state debris resulting from the reduction process of low temperature reducer 203. In various embodiments, these solids 209 from low temperature reducer 203 are removed from decoupled CLR based syngas production system 201. Again, this is in direct contrast to prior art systems which recycled the metal oxides converting the reduced metal component to oxidized metal and oxidized metal to reduced metal over and over again in a closed loop.

Consequently, solids 209 includes unreacted fuel 201, now mostly unconverted carbon, ash, and biochar mixed with the now reduced metal and/or metal oxides such as reduced Fe₃O₄, FCO, Fe, MnO, Mn₃O₄, Mn₂O₃, MnO₂, MnO₃, Mn, Mg, SnO, Sn, TiO, Ti₂O₃, Ti, WO₂, W₂O₃, W, NIO, Ni, Al₂O, AlO, Al, Cu₂O₃, CuO₂, CuO, Cu₂O, Cu, MoO₂, Ce₂O₃, Ce₃O₄, and Ce.

As discussed below, in one embodiment, the reduced metal oxides in solids 209 are separated from the solids product and are stored, sold, and/or sent to a separate oxidation reactor. Thus, in direct contrast to the prior art, decoupled CLR based syngas production system 201 includes open loop solids processing that is decoupled from decoupled CLR based syngas production system 201. Consequently, using decoupled CLR based syngas production system 201, and in contrast to prior art teachings, oxidized metal can be created and/or obtained from processes performed at a different location or performed at a different time, i.e., oxidation of oxidized metal 202 need not to performed either on-site or in real time. One advantage of this configuration is that the oxidized metal 202 can be lower temperature, in fact oxidized metal 202 can be provided at any temperature desired. This is in contrast to the prior systems where the oxidized metal is provided from within the system and in virtually real time and is therefore typically very high temperature, such as the 1,100 degree Celsius.

In one embodiment, vapor 208, i.e., the gas from low temperature reducer 203, is the base for the creation of syngas. Consequently, in one embodiment, vapor 208 is provided to high temperature reformer 211 for further processing.

In various embodiments, solid/gas separator 207 can be a cyclone, and/or a gravity-based system, including a long pipe, and/or a mechanical based system like a filter/screen, where the solids 209, such as reduced metal, ash and carbon biochar, and metal sulfides from the low temperature reduction process of low temperature reducer 203, are separated from the resultant vapor 208 from the low temperature reduction process of low temperature reducer 203.

Solid/gas separators, such as solid/gas separator 207, are well known in the art. Consequently, a more detailed discussion of the operation of any particular solid/gas separator 207 is omitted here to avoid detracting from the invention. In various embodiments, solid/gas separator 207 can be any system capable of separating solids 209, such as reduced metal, ash and carbon biochar, and metal sulfides, from the resultant vapor 208 of the low temperature reduction process of low temperature reducer 203, as discussed herein, and/or known in the art at the time of filing, and/or as developed/made available after the time of filing.

As discussed in more detail below, in some embodiments, once solids 209, such as reduced metal, ash and carbon biochar, and metal sulfides, are separated from the resultant vapor 208, magnets can be used to separate the reduced metal in solids 209 from the ash and carbon biochar in solids 209. As also discussed below, in some embodiments, once the reduced metal is separated from the ash and carbon biochar, magnets can also be used to separate reduced metal from metal sulfides.

As noted above, vapor 208, i.e., the gas from low temperature reducer 203 is the base for the creation of syngas. Consequently, vapor 208 is provided to high temperature reformer 211.

In some embodiments, in addition to vapor 208, high temperature reformer 211 is also provided other sources of oxygen and/or heat 213. In various embodiments, the sources of oxygen can include steam, water, and/or elemental oxygen, or any other source of oxygen as discussed herein, and or as known in the art at the time of filing, and/or as developed/made available after the time of filing.

In one embodiment, high temperature reformer 211 is provided supplementary heat from an external heat source, such as an electric heating element so that the temperature of the reduction reactions taking place in high temperature reformer 211 can be controlled separately from the temperature of low temperature reducer 203. In this way separate reaction temperature zones can be created for low temperature reducer 203 and high temperature reformer 211.

In one embodiment, vapor 208 continues through a 700° C. or hotter gasification zone of high temperature reformer zone 211, further reacting with steam to produce syngas 215.

In one embodiment, as a result of the processing performed at high temperature reformer 211, vapor 208 is transformed into syngas 215.

The operation of high temperature reformers, such as high temperature reformer 211, is well known in the art. Consequently, a more detailed discussion of any particular embodiment of high temperature reformer 211 is omitted here to avoid detracting from the invention. In various embodiments, high temperature reformer 211 can be any high temperature reformer capable of generating syngas from vapors provided from low temperature reducer reduction reactions of a low temperature reducer as discussed herein, and/or as known in the art at the time of filing, and/or as developed/made available after the time of filing.

In one embodiment, the resultant syngas 215 from the reactions taking place in high temperature reformer 211 is then provided to gas treatment station 217 where the syngas 215 is used to produce products 219. In various embodiments, products 219 can include, but are not limited to hydrogen, methanol, ethanol, synthetic fuels, waxes, acetic acid, formaldehyde, methyl acetate, acetic anhydride, ethylene, propylene, acrylic acid, alpha olefins, dimethyl ether, ammonia, urea, ammonium nitrate, acrylonitrile, electricity, various chemicals and the like.

The various methods and systems for converting syngas into various products represented by gas treatment station 217 are well known in the art. Consequently, a more detailed discussion of the operation of any specific method or process represented by gas treatment station 217 is omitted here to avoid detracting from the invention. In various embodiments, the methods and systems for converting syngas into various products represented by gas treatment station 217 can be any methods and systems for converting syngas into various products as discussed herein and/or as known in the art at the time of filing, and/or as developed/made available after the time of filing.

As seen in FIG. 2A, using the disclosed decoupled CLR based syngas production systems and processes, the processing moves a direction 168, which is also the direction of increasing temperature through low temperature reducer 203 and high temperature reformer 211. Higher temperatures are required to produce the desired syngas product.

As noted above, in one embodiment, the solids 209 from low temperature reducer and solid/gas separator 207 are fed to a solid separation section where the solids are further separated into ash/carbon/biochar solids and reduced metal.

FIG. 2B is a block diagram of one embodiment of a decoupled CLR based syngas production system 220 including solids separator 231 where solids 209 from low temperature reducer and solid/gas separator 207 are separated into ash and/or carbon biochar 210 and reduced metal 233.

The operation of decoupled CLR based syngas production system 220 of FIG. 2B is substantially similar to the operation of decoupled CLR based syngas production system 201 of FIG. 2A discussed above. Consequently, the discussion above with respect to decoupled CLR based syngas production system 201 applies to the decoupled CLR based syngas production system 220 discussed below.

As seen in FIG. 2B, using decoupled CLR based syngas production system 220 solids 209, e.g., reduced metal oxides, ash, charcoal, biochar, and other solid-state debris resulting from the reduction process of low temperature reducer 203, are fed from solid/gas separator 207 to solids separator 231. In one embodiment, solids separator 231 separates the reduced metal oxides from the ash, charcoal, biochar, and other solid-state debris resulting from the reduction process of low temperature reducer 203, to generate ash and/or carbon biochar 210 and reduced metal 233.

In various embodiments, ash and/or carbon biochar 210 can then be sold/used as organic biochar and/or as a soil supplement. In addition, in one embodiment, the reduced metal 233 can be stored on site for future use and/or sale. In one embodiment, reduced metal 233 can be oxidized to generate oxidized metal. However, in direct contrast to prior teachings, using the disclosed embodiments, reduced metal 233 can be oxidized to generate oxidized metal in a process that can be separate, both physically and temporally, from the operation of the disclosed decoupled CLR based syngas production systems.

Specifically, in various embodiments, including decoupled CLR based syngas production system 220, oxidized metal 202 does not necessarily come from the oxidation of reduced metal 233 and reduced metal 233 can be oxidized in a separate operation at any location, at any time desired, and by any methods desired. This is in direct contrast to the prior art teachings of the use of closed loop oxidation and reduction cycles discussed above. Thus, decoupled CLR based syngas production system 220 includes open loop solids processing that is decoupled from decoupled CLR based syngas production system 220.

Consequently, using decoupled CLR based syngas production system 220, and in contrast to prior art teachings, oxidized metal can be created and/or obtained from processes performed at a different location or performed at a different time, i.e., oxidation of oxidized metal 202 need not to performed either on-site or in real time. One advantage of this configuration is that the oxidized metal 202 can be lower temperature, in fact oxidized metal 202 can be provided at any temperature desired. This is in contrast to the prior systems where the oxidized metal is provided from within the system and in virtually real time and is therefore typically very high temperature, such as the 1.100 degree Celsius.

The operation of solids separators, such as solids separator 231, is well known in the art. Consequently, a more detailed discussion of the operation of any specific solids separator is omitted here to avoid detracting from the invention. In various embodiments, solids separator 231 can separate reduced metal oxides from the ash, charcoal, biochar, and other solid-state debris resulting from the reduction process of low temperature reducer 203 using various known methods and systems including, but not limited to, gravity/density based separation, sluice box separation, magnets, and/or any other methods and systems for separating reduced metal oxides from ash, charcoal, biochar, and other solid-state debris resulting from the reduction process of a low temperature reducer, as discussed herein, and/or as known in the art at the time of filing, and/or as become known after the time of filing.

In one embodiment, the reduced metal 233 can be further separated into reduced metal and reduced metal sulfides by a sulfide separator.

FIG. 2C is a block diagram of one embodiment of a decoupled CLR based syngas production system 230 including solids separator 231, where solids 209 from low temperature reducer and solid/gas separator 207 are separated into ash and/or carbon biochar 210 and reduced metal 233, and sulfide separator 232 where metal sulfides are separated from reduced metal 233.

The operation of decoupled CLR based syngas production system 230 of FIG. 2C is substantially similar to the operation of decoupled CLR based syngas production system 201 of FIG. 2A and decoupled CLR based syngas production system 220 of FIG. 2B, discussed above. Consequently, the discussion above with respect to decoupled CLR based syngas production system 201 and decoupled CLR based syngas production system 220 applies to the decoupled CLR based syngas production system 230 discussed below.

As seen in FIG. 2C, using decoupled CLR based syngas production system 230 solids 209, e.g., reduced metal oxides, ash, charcoal, biochar, and other solid-state debris resulting from the reduction process of low temperature reducer 203, are fed from solid/gas separator 207 to solids separator 231. In one embodiment, solids separator 231 separates the reduced metal oxides from the ash, charcoal, biochar, and other solid-state debris resulting from the reduction process of low temperature reducer 203, to generate ash and/or carbon biochar 210 and reduced metal 233.

In various embodiments, ash and/or carbon biochar 210 can then be sold/used as organic biochar and/or as a soil supplement. In addition, in one embodiment, the reduced metal 233 can be stored on site for future use and/or sale. In one embodiment, reduced metal 233 can be oxidized to generate oxidized metal.

Of note, in various embodiments, including decoupled CLR based syngas production systems 220 and 230, oxidized metal 202 does not necessarily come from the oxidation of reduced metal 233 and reduced metal 233 can be oxidized in a separate operation at any location, at any time desired, and by any methods desired. This is in direct contrast to the prior art and the use of closed loop oxidation and reduction cycles discussed above. Thus, decoupled CLR based syngas production systems 201, 220, and 230 include open loop solids processing that is decoupled from decoupled CLR based syngas production systems 201, 220, and 230.

Consequently, using decoupled CLR based syngas production system 230, and in contrast to prior art teachings, oxidized metal can be created and/or obtained from processes performed at a different location or performed at a different time, i.e., oxidation of oxidized metal 202 need not to performed either on-site or in real time. One advantage of this configuration is that the oxidized metal 202 can be lower temperature, in fact oxidized metal 202 can be provided at any temperature desired. This is in contrast to the prior systems where the oxidized metal is provided from within the system and in virtually real time and is therefore typically very high temperature, such as the 1,100 degree Celsius.

The operation of solids separators, such as solids separator 231, is well known in the art. Consequently, a more detailed discussion of the operation of any specific solids separator is omitted here to avoid detracting from the invention. In various embodiments, solids separator 231 can separate reduced metal oxides from the ash, charcoal, biochar, and other solid-state debris resulting from the reduction process of low temperature reducer 203 using various known methods and systems including, but not limited to, gravity/density based separation, sluice box separation, magnets, and/or any other methods and systems for separating reduced metal oxides from ash, charcoal, biochar, and other solid-state debris resulting from the reduction process of a low temperature reducer, as discussed herein, and/or as known in the art at the time of filing, and/or as become known after the time of filing.

Referring back to FIG. 2C and decoupled CLR based syngas production system 230, once reduced metal 233 is separated out by solids separator 231, the reduced metal 233 includes both pure reduced metal 234 and metal sulfides 241. At sulfide separator 232, reduced metal 234 is separated from metal sulfides 241.

The operation of sulfide separators, such as sulfide separator 232, is well known in the art. Consequently, a more detailed discussion of the operation of any specific sulfide separator is omitted here to avoid detracting from the invention. In various embodiments, sulfide separator 232 can separate reduced metal 234 from metal sulfides 241 using various known methods and systems including, but not limited to, gravity/density based separation, sluice box separation, magnets, and/or any other methods and systems for separating reduced metal from metal sulfides as discussed herein, and/or as known in the art at the time of filing, and/or as become known after the time of filing.

In one embodiment, the metal sulfides 241 separated from reduced metal 234 are subjected to a sulfur treatment to separate the sulfur from the metal sulfides 241 to create reduced metal 234 and elemental sulfur.

FIG. 2D is a block diagram of one embodiment of a decoupled CLR based syngas production system 240 including solids separator 231, where solids 209 from low temperature reducer and solid/gas separator 207 are separated into ash and/or carbon biochar 210, sulfide separator 232 where metal sulfides 241 are separated from reduced metal 234, and sulfur treatment station 243 where elemental sulfur is removed from metal sulfides 241 to create additional reduced metal 234.

The operation of decoupled CLR based syngas production system 240 of FIG. 2D is substantially similar to the operation of decoupled CLR based syngas production system 201 of FIG. 2A, decoupled CLR based syngas production system 220 of FIG. 2B, and decoupled CLR based syngas production system 230 of FIG. 2C discussed above. Consequently, the discussion above with respect to decoupled CLR based syngas production system 201, decoupled CLR based syngas production system 220, and decoupled CLR based syngas production system 230 applies to decoupled CLR based syngas production system 240 discussed below.

As seen in FIG. 2D, using decoupled CLR based syngas production system 240 solids 209, e.g., reduced metal oxides, ash, charcoal, biochar, and other solid-state debris resulting from the reduction process of low temperature reducer 203, are fed from solid/gas separator 207 to solids separator 231. In one embodiment, solids separator 231 separates the reduced metal oxides from the ash, charcoal, biochar, and other solid-state debris resulting from the reduction process of low temperature reducer 203, to generate ash and/or carbon biochar 210 and reduced metal 233.

In various embodiments, ash and/or carbon biochar 210 can then be sold/used as organic biochar and/or as a soil supplement. In addition, in one embodiment, the reduced metal 233 is stored on site for future use and/or sale. In one embodiment, reduced metal 233 can be oxidized to generate oxidized metal in an oxidation operation that can be sperate, in both location and/or time, from decoupled CLR based syngas production system 240.

That is to say, in various embodiments, including decoupled CLR based syngas production systems 201, 220, 230, and 240, oxidized metal 202 does not necessarily come from the oxidation of reduced metal 233/234 and reduced metal 233/234 can be oxidized in a separate operation at any location, at any time desired, and by any methods desired. This is in direct contrast to the prior art and the use of closed loop oxidation and reduction cycles discussed above. Thus, decoupled CLR based syngas production systems 201, 220, 230, and 240 include open loop solids processing that is decoupled from the CLR based syngas production systems.

Consequently, using decoupled CLR based syngas production system 240, and in contrast to prior art teachings, oxidized metal can be created and/or obtained from processes performed at a different location or performed at a different time, i.e., oxidation of oxidized metal 202 need not to performed either on-site or in real time. One advantage of this configuration is that the oxidized metal 202 can be lower temperature, in fact oxidized metal 202 can be provided at any temperature desired. This is in contrast to the prior systems where the oxidized metal is provided from within the system and in virtually real time and is therefore typically very high temperature, such as the 1,100 degree Celsius.

The operation of solids separators, such as solids separator 231, is well known in the art. Consequently, a more detailed discussion of the operation of any specific solids separator is omitted here to avoid detracting from the invention. In various embodiments, solids separator 231 can separate reduced metal oxides from the ash, charcoal, biochar, and other solid-state debris resulting from the reduction process of low temperature reducer 203 using various known methods and systems including, but not limited to, gravity/density based separation, sluice box separation, magnets, and/or any other methods and systems for separating reduced metal oxides from ash, charcoal, biochar, and other solid-state debris resulting from the reduction process of a low temperature reducer, as discussed herein, and/or as known in the art at the time of filing, and/or as become known after the time of filing.

Once reduced metal 233 is separated out by solids separator 231, the reduced metal 233 includes both pure reduced metal 234 and metal sulfides 241. At sulfide separator 232, reduced metal 234 is separated from metal sulfides 241.

The operation of sulfide separators, such as sulfide separator 232, is well known in the art. Consequently, a more detailed discussion of the operation of any specific sulfide separator is omitted here to avoid detracting from the invention. In various embodiments, sulfide separator 232 can separate reduced metal 234 from metal sulfides 241 using various known methods and systems including, but not limited to, gravity/density based separation, sluice box separation, magnets, and/or any other methods and systems for separating reduced metal from metal sulfides as discussed herein, and/or as known in the art at the time of filing, and/or as become known after the time of filing.

Referring back to FIG. 2D and decoupled CLR based syngas production system 240, in one embodiment, the metal sulfides 241 separated from reduced metal 234 are subjected to a sulfur treatment 243 to separate the sulfur 245 from the metal sulfides 241 to create reduced metal 234 and sulfur 245.

The operation of various types of sulfur treatments, such as sulfur treatment 243, is well known in the art. Consequently, a more detailed discussion of the operation of any specific sulfur treatment 243 is omitted here to avoid detracting from the invention. In various embodiments, sulfur treatment 243 can separate sulfur from metal sulfides using various known methods and systems including, but not limited to electrochemical, oxidation, or acid processes, or any other sulfur treatment methods and/or systems, as discussed herein, and/or as known in the art at the time of filing, and/or as become known after the time of filing.

In some embodiments, the resulting ash/carbon/biochar solids 210 and elemental sulfur 245 are then used for various purposes including but not limited to organic soil amendments and in various chemical compounds.

In various embodiments, the reduced metal produced by the disclosed decoupled CLR based syngas production systems is provided to an oxidizer which the oxidizes the reduced metal outside the disclosed decoupled CLR based syngas production systems.

FIG. 2E is a block diagram of one embodiment of a decoupled CLR based syngas production system 250 including solids separator 231 where solids 209 from low temperature reducer and solid/gas separator 207 are separated into ash and/or carbon biochar 210 and reduced metal 233, and separate oxidizer 235 which oxidizes reduced metal 233 into oxidized metal 237 in a separate, uncoupled operation.

The operation of decoupled CLR based syngas production system 250 of FIG. 2E is substantially similar to the operation of decoupled CLR based syngas production system 201 of FIG. 2A discussed above. Consequently, the discussion above with respect to decoupled CLR based syngas production system 201 applies to decoupled CLR based syngas production system 250 discussed below.

As seen in FIG. 2E, using decoupled CLR based syngas production system 250 solids 209, e.g., reduced metal oxides, ash, charcoal, biochar, and other solid-state debris resulting from the reduction process of low temperature reducer 203, are fed from solid/gas separator 207 to solids separator 231. In one embodiment, solids separator 231 separates the reduced metal oxides from the ash, charcoal, biochar, and other solid-state debris resulting from the reduction process of low temperature reducer 203, to generate ash and/or carbon biochar 210 and reduced metal 233.

The operation of solids separators, such as solids separator 231, is well known in the art. Consequently, a more detailed discussion of the operation of any specific solids separator is omitted here to avoid detracting from the invention. In various embodiments, solids separator 231 can separate reduced metal oxides from the ash, charcoal, biochar, and other solid-state debris resulting from the reduction process of low temperature reducer 203 using various known methods and systems including, but not limited to, gravity/density based separation, sluice box separation, magnets, and/or any other methods and systems for separating reduced metal oxides from ash, charcoal, biochar, and other solid-state debris resulting from the reduction process of a low temperature reducer, as discussed herein, and/or as known in the art at the time of filing, and/or as become known after the time of filing.

In various embodiments, ash and/or carbon biochar 210 can then be sold/used as organic biochar and/or as a soil supplement. In addition, in one embodiment, the reduced metal 233 can be stored on site for future use and/or sale. However, in one embodiment of decoupled CLR based syngas production system 250, reduced metal 233 is fed to an oxidizer 235 to generate oxidized metal 237.

Of note, in various embodiments, including decoupled CLR based syngas production system 250, oxidized metal 202 does not necessarily come from the oxidation of reduced metal 233 and need not be oxidized metal 237 generated from the separate, uncoupled, oxidation process at oxidizer 235. That is to say, using decoupled CLR based syngas production system 250, reduced metal 233 can be oxidized in a separate operation at any time desired, at any place desired, and by any methods desired, using oxidizer 235. This is in direct contrast to the prior art and the use of closed loop oxidation and reduction cycles discussed above. Thus, decoupled CLR based syngas production system 250 includes open loop solids processing that is decoupled from decoupled CLR based syngas production system 250.

Consequently, using decoupled CLR based syngas production system 250, and in contrast to prior art teachings, oxidized metal can be created and/or obtained from processes performed at a different location or performed at a different time, i.e., oxidation of oxidized metal 202 need not to performed either on-site or in real time. One advantage of this configuration is that the oxidized metal 202 can be lower temperature, in fact oxidized metal 202 can be provided at any temperature desired. This is in contrast to the prior systems where the oxidized metal is provided from within the system and in virtually real time and is therefore typically very high temperature, such as the 1,100 degree Celsius.

The operation of oxidizers, e.g., oxidation reactors, such as oxidizer 235, is well known in the art. Consequently, a more detailed discussion of the operation of any specific oxidizer 235 is omitted here to avoid detracting from the invention. In various embodiments, oxidizer 235 can oxidize reduced metals, such as reduced metal 233, to generate oxidized metals, such as oxidized metal 237, using various known methods and systems as discussed herein, and/or as known in the art at the time of filing, and/or as become known after the time of filing.

In one embodiment, the metal sulfides are separated from reduced metal and the metal sulfides are subjected to a sulfur treatment to separate the sulfur from the metal sulfides to create reduced metal and elemental sulfur. The reduced metal is then fed to an oxidizer to generate oxidized metal.

FIG. 2F is a block diagram of one embodiment of a decoupled CLR based syngas production system 260 including solids separator 231, where solids 209 from low temperature reducer and solid/gas separator 207 are separated into ash and/or carbon biochar 210, sulfide separator 232 where metal sulfides 241 are separated from reduced metal 234, sulfur treatment station 243 where sulfur 245 is removed from metal sulfides 241 to create additional reduced metal 234, and separate oxidizer 235 which oxidizes reduced metal 234 into oxidized metal 237 in a separate, uncoupled operation.

The operation of decoupled CLR based syngas production system 260 of FIG. 2F is substantially similar to the operation of decoupled CLR based syngas production system 201 of FIG. 2A, decoupled CLR based syngas production system 220 of FIG. 2B, decoupled CLR based syngas production system 230 of FIG. 2C, decoupled CLR based syngas production system 240 of FIG. 2D, and decoupled CLR based syngas production system 250 of FIG. 2E, discussed above. Consequently, the discussion above with respect to decoupled CLR based syngas production system 201, decoupled CLR based syngas production system 220, and decoupled CLR based syngas production system 230, decoupled CLR based syngas production system 240, and decoupled CLR based syngas production system 250 applies to the decoupled CLR based syngas production system 260 discussed below.

As seen in FIG. 2F, using decoupled CLR based syngas production system 260 solids 209, e.g., reduced metal oxides, ash, charcoal, biochar, and other solid-state debris resulting from the reduction process of low temperature reducer 203, are fed from solid/gas separator 207 to solids separator 231. In one embodiment, solids separator 231 separates the reduced metal oxides from the ash, charcoal, biochar, and other solid-state debris resulting from the reduction process of low temperature reducer 203, to generate ash and/or carbon biochar 210 and reduced metal 233.

In various embodiments, ash and/or carbon biochar 210 can then be sold/used as organic biochar and/or as a soil supplement. In addition, in one embodiment, the reduced metal 233 can be stored on site for future use and/or sale. In one embodiment, reduced metal 233 can be oxidized to generate oxidized metal in a sperate location, at a separate time, and in a separate operation.

Consequently, in various embodiments, including decoupled CLR based syngas production systems 201, 220, 230, 240, 250, and 260, oxidized metal 202 does not necessarily come from the oxidation of reduced metal 233/234 and reduced metal 233/234 can be oxidized in a separate operation at any time desired, at any location desired, and by any methods desired. This is in direct contrast to the prior art and the use of closed loop oxidation and reduction cycles discussed above. Thus, decoupled CLR based syngas production systems 201, 220, 230, 240, 250 and 260 include open loop solids processing that is decoupled from the decoupled CLR based syngas production systems.

The operation of solids separators, such as solids separator 231, is well known in the art. Consequently, a more detailed discussion of the operation of any specific solids separator is omitted here to avoid detracting from the invention. In various embodiments, solids separator 231 can separate reduced metal oxides from the ash, charcoal, biochar, and other solid-state debris resulting from the reduction process of low temperature reducer 203 using various known methods and systems including, but not limited to, gravity/density based separation, sluice box separation, magnets, and/or any other methods and systems for separating reduced metal oxides from ash, charcoal, biochar, and other solid-state debris resulting from the reduction process of a low temperature reducer, as discussed herein, and/or as known in the art at the time of filing, and/or as become known after the time of filing.

Once reduced metal 233 is separated out by solids separator 231, the reduced metal 233 includes both pure reduced metal 234 and metal sulfides 241. At sulfide separator 232, reduced metal 234 is separated from metal sulfides 241.

The operation of sulfide separators, such as sulfide separator 232, is well known in the art. Consequently, a more detailed discussion of the operation of any specific sulfide separator is omitted here to avoid detracting from the invention. In various embodiments, sulfide separator 232 can separate reduced metal 234 from metal sulfides 241 using various known methods and systems including, but not limited to, gravity/density based separation, sluice box separation, magnets, and/or any other methods and systems for separating reduced metal from metal sulfides as discussed herein, and/or as known in the art at the time of filing, and/or as become known after the time of filing.

In one embodiment, the metal sulfides 241 separated from reduced metal 234 are subjected to a sulfur treatment 243 to separate the sulfur from the metal sulfides 241 to create reduced metal 234 and sulfur 245.

The operation of various types of sulfur treatments, such as sulfur treatment 243, is well known in the art. Consequently, a more detailed discussion of the operation of any specific sulfur treatment 243 is omitted here to avoid detracting from the invention. In various embodiments, sulfur treatment 243 can separate sulfur from metal sulfides using various known methods and systems including, but not limited to, electrochemical, oxidation, and acid processes, or any other sulfur treatment methods and/or systems, as discussed herein, and/or as known in the art at the time of filing, and/or as become known after the time of filing.

In some embodiments, the resulting ash/carbon/biochar solids 210 and elemental sulfur 245 are then used for various purposes including but not limited to organic soil amendments and the production of various chemical compounds.

Referring back to FIG. 2F, and decoupled CLR based syngas production system 260, in some embodiments, the reduced metal 234 is stored on site for future use and/or sale. However, in one embodiment of decoupled CLR based syngas production system 260, reduced metal 234 is eventually fed to oxidizer 235 to generate oxidized metal 237.

Of note, in various embodiments, including decoupled CLR based syngas production system 260, oxidized metal 202 does not necessarily come from the oxidation of reduced metal 234 and need not be oxidized metal 237 generated from the separate, uncoupled, oxidation process at oxidizer 235. That is to say, using decoupled CLR based syngas production system 260, reduced metal 234 can be oxidized in a separate operation at any time desired, at any location desired, and by any methods desired using oxidizer 235. This is in direct contrast to the prior art and the use of closed loop oxidation and reduction cycles discussed above. Thus, decoupled CLR based syngas production system 260 includes open loop solids processing that is decoupled from decoupled CLR based syngas production system 260.

The operation of oxidizers, e.g., oxidation reactors, such as oxidizer 235, is well known in the art. Consequently, a more detailed discussion of the operation of any specific oxidizer 235 is omitted here to avoid detracting from the invention. In various embodiments, oxidizer 235 can oxidized reduced metals, such as reduced metal 233, to generate oxidized metals, such as oxidized metal 237, using various known methods and systems as discussed herein, and/or as known in the art at the time of filing, and/or as become known after the time of filing.

In some embodiments, the oxidized metal 237 can be fed back into the low temperature reducer 203. However, using the disclosed embodiments, the process need not wait for oxidized metal 237 to be generated, but can operate on any oxidized metal 202 from any source.

FIG. 2G shows a decoupled CLR based syngas production system 270 where the oxidized metal 237 is optionally fed back into low temperature reducer 203. Decoupled CLR based syngas production system 270 of FIG. 2G includes solids separator 231 where solids 209 from low temperature reducer and solid/gas separator 207 are separated into ash and/or carbon biochar 210 and reduced metal 233, and oxidizer 235 which oxidizes reduced metal 233 into oxidized metal 237 in a separate, operation. Oxidized metal 237 can then be fed to low temperature reducer 203.

The operation of decoupled CLR based syngas production system 270 of FIG. 2G is substantially similar to the operation of decoupled CLR based syngas production system 250 of FIG. 2E discussed above. Consequently, the discussion above with respect to decoupled CLR based syngas production system 250 applies to decoupled CLR based syngas production system 270 discussed below.

As seen in FIG. 2G, using decoupled CLR based syngas production system 270 solids 209, e.g., reduced metal oxides, ash, charcoal, biochar, and other solid-state debris resulting from the reduction process of low temperature reducer 203, are fed from solid/gas separator 207 to solids separator 231. In one embodiment, solids separator 231 separates the reduced metal oxides from the ash, charcoal, biochar, and other solid-state debris resulting from the reduction process of low temperature reducer 203, to generate ash and/or carbon biochar 210 and reduced metal 233.

The operation of solids separators, such as solids separator 231, is well known in the art. Consequently, a more detailed discussion of the operation of any specific solids separator is omitted here to avoid detracting from the invention. In various embodiments, solids separator 231 can separate reduced metal oxides from the ash, charcoal, biochar, and other solid-state debris resulting from the reduction process of low temperature reducer 203 using various known methods and systems including, but not limited to, gravity/density based separation, sluice box separation, magnets, and/or any other methods and systems for separating reduced metal oxides from ash, charcoal, biochar, and other solid-state debris resulting from the reduction process of a low temperature reducer, as discussed herein, and/or as known in the art at the time of filing, and/or as become known after the time of filing.

In various embodiments, ash and/or carbon biochar 210 can then be sold/used as organic biochar and/or as a soil supplement. In addition, in one embodiment, the reduced metal 233 can be stored on site for future use and/or sale. However, in one embodiment of decoupled CLR based syngas production system 250, reduced metal 233 is fed to oxidizer 235 to generate oxidized metal 237.

Of note, while in one embodiment of decoupled CLR based syngas production system 270 oxidized metal 237 does come from the oxidation of reduced metal 233, all or part of the oxidized metal can include oxidized metal 202 that comes from a separate, uncoupled, oxidation process and need not be all oxidized metal 237 from the oxidation process at oxidizer 235. This is in direct contrast to the prior art and the use of closed loop oxidation and reduction cycles discussed above. Thus, decoupled CLR based syngas production system 270 can include open loop solids processing that is decoupled from decoupled CLR based syngas production system 270.

The operation of oxidizers, e.g., oxidation reactors, such as oxidizer 235, is well known in the art. Consequently, a more detailed discussion of the operation of any specific oxidizer 235 is omitted here to avoid detracting from the invention. In various embodiments, oxidizer 235 can oxidize reduced metals, such as reduced metal 233, to generate oxidized metals, such as oxidized metal 237, using various known methods and systems as discussed herein, and/or as known in the art at the time of filing, and/or as become known after the time of filing.

FIG. 2H shows a decoupled CLR based syngas production system 280 that is substantially similar to decoupled CLR based syngas production system 260 of FIG. 2F except that using decoupled CLR based syngas production system 280 the oxidized metal 237 from oxidizer 235 is fed back into low temperature reducer 203.

As noted, decoupled CLR based syngas production system 280 is substantially similar to decoupled CLR based syngas production system 260 of FIG. 2F, consequently, the discussion above with respect to decoupled CLR based syngas production system 260 applies to decoupled CLR based syngas production system 280 discussed below.

As seen in FIG. 2H using one embodiment of decoupled CLR based syngas production system 280 oxidized metal 237 does come from the oxidation of reduced metal 234. However, all or part of the oxidized metal can include oxidized metal 202 that comes from come from a separate, uncoupled, oxidation process and need not be all or part oxidized metal 237 from the oxidation process at oxidizer 235. This is in direct contrast to the prior art and the use of closed loop oxidation and reduction cycles discussed above. Thus, decoupled CLR based syngas production system 280 can include open loop solids processing that is decoupled from decoupled CLR based syngas production system 280.

Embodiments of the present disclosure provide a solution to the long-standing technical problem of providing methods for producing syngas using CLR based syngas production processes that do not suffer from the drawbacks associated with prior art closed and coupled loop metal oxidation and reduction methods.

To this end, disclosed herein are CLR based syngas production processes where the metal oxidation and reduction sub-systems are decoupled CLR based syngas production processes; thereby avoiding the closed and coupled loop metal oxidation and reduction requirement of prior art CLR based syngas production processes, and the high temperature complexities associated with prior art CLR based syngas production processes.

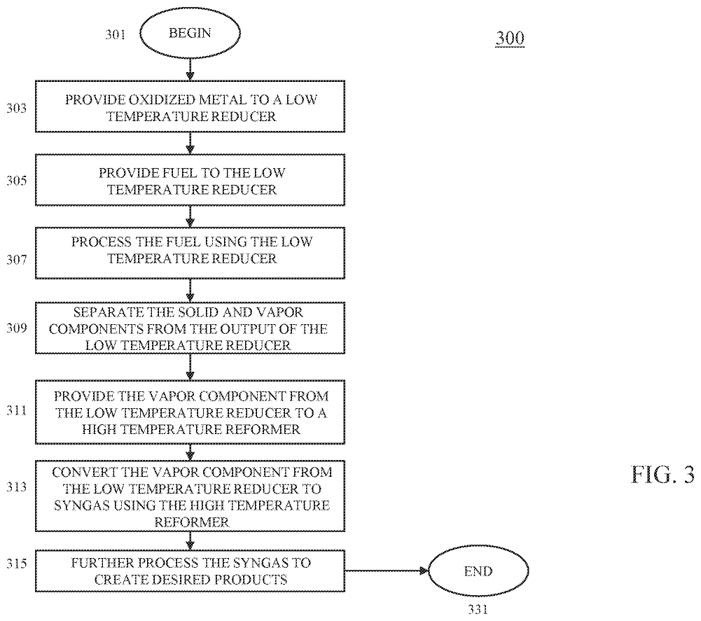

FIG. 3 is a simplified flow chart of a process 300 for the production of syngas that shows some of the operations performed in one embodiment of the disclosed decoupled CLR based syngas production processes.

As seen in FIG. 3, process 300 begins at operation 301 and process flow proceeds to operation 303 where oxidized metal is provided to a low temperature reducer.

In various embodiments, the low temperature reducer provided at operation 303 can be any low temperature reducer capable of supporting low temperature reduction reactions as discussed herein, and or as known in the art at the time of filing, and/or as developed/made available after the time of filing.

As noted herein, the general operation and structure of low temperature reducers is well known in the art. Consequently, a more detailed discussion of any specific example of low temperature reducer is omitted here to avoid detracting from the invention.

In one embodiment, the oxidized metal provided to the low temperature reducer at 303 can be from any source, including sources outside the decoupled CLR based syngas production process 400. This is in direct contrast to prior art CLR based syngas production processes that require that the same metal oxides be reduced and oxidized in a continuous closed loop that is part of the overall prior art CLR based syngas production processes.

Thus, using the disclosed embodiments, and in direct contrast to the prior art, the oxidized metal provided to the low temperature reducer at 303 need not come from within decoupled CLR based syngas production process 400. One advantage of this configuration is that the oxidized metal can be lower temperature, in fact they can be any temperature desired. This is in contrast to the prior systems where the oxidized metal is typically very high temperature, such as 1,100 degrees Celsius.

In specific illustrative examples, the oxidized metal provided to the low temperature reducer at 303 can be Fe₃O₄, Fe₂O₃, Mn₂O₇, Mn₃O₄, Mn₂O₃, MnO₂, MnO₃, MgO, SnO₂, TiO₂, Ti₂O₃, WO₃, WO₂, Ni₂O₃, NiO, Al₂O₃, AlO, Cu₂O₃, CuO₂, CuO, MoO₃ CeO₂, and Ce₃O₄. However, the oxidized metal provided to the low temperature reducer at 303 can be any oxidized form of virtually any metal, including, but not limited to iron, nickel, aluminum, or any other metal capable of being oxidized and reduced and providing oxygen as discussed herein, and or as known in the art at the time of filing, and/or as developed/made available after the time of filing.

In some embodiments, the oxidized metal provided to the low temperature reducer at 303 is in the form of a coating on a substrate material (not shown). In various embodiments, the substrate material can be, but is not limited to, Al₂O₃, CaAl₂O₄, TiO₂, ZrO₂, carbon, silica, zeolites, silicon nitride, aluminum nitride, silicon carbide, cordierite, alumina-silicate (e.g., mullite, illite, kaolinite), steatite, YSZ ceramic, and SiAlON ceramic or any combination thereof. However, in some embodiments, the substrate material can be any material as discussed herein, and or as known in the art at the time of filing, and/or as developed/made available after the time of filing capable of providing a substrate for metal oxides.

Once oxidized metal is proved to a low temperature reducer at operation 403, process flow proceeds to 305 where fuel is provided to the low temperature reducer.

In various embodiments, the fuel provided to the low temperature reducer at operation 305 is in the form of liquid or solid organic material. In various embodiments, the fuel provided to the low temperature reducer at operation 305 can be any organic material, in either a solid or fluid form, such as, but not limited to, natural gas, landfill gas, petroleum gas, liquid petroleum, biomass, domestic and industrial refuse, refuse derived fuel, sewage, black liquor, coal, coke, animal waste, tar, oil shale, or any other source of carbon containing material.

In one embodiment, the fuel provided to the low temperature reducer at operation 305 can be Refuse-Derived Fuel (RDF). RDF is a fuel produced from various types of waste such as municipal solid waste (MSW), industrial waste, or commercial waste.

In various embodiments, at operation 305 other sources of oxygen and/or heat (not shown in FIG. 3) can optionally be provided to the low temperature reducer. In various embodiments, the sources of oxygen can include steam, water, chemical oxygen (e.g., H2O2) and/or elemental oxygen, or any other source of oxygen as discussed herein, and or as known in the art at the time of filing, and/or as developed/made available after the time of filing.

In one embodiment, at operation 305 the low temperature reducer is optionally provided supplementary heat from an external heat source, such as an electric heating element (not shown in FIG. 3). In these embodiments, the temperature of the reduction reactions taking place in low temperature reducer can be controlled to increase efficiency and/or avoid high temperature related issues such as deformation, sintering, plugging of transfer mechanisms and pipes, fouling, and erosion.

Once fuel is provided to the low temperature reducer at operation 405, process flow proceeds to 307 where the low temperature reducer is used to process the fuel provided.

In various embodiments, at operation 307 low temperature reducer is used to process the fuel provided at operation 305 thereby creating solids and vapor and reducing the metal oxides provided at operation 403.

In one embodiment, the reduction reactions taking place in the low temperature reducer at operation 305 include the thermal decomposition of materials at elevated temperature to effect a change of chemical composition of the fuel.

In one embodiment, the reduction reactions taking place in the low temperature reducer at 307 convert the fuel into volatile products, i.e., vapor, and various organic solids and reduced metal and metal sulfides. The reduction reactions taking place in low temperature reducer at 307 are the first step in the processes of gasification for production of syngas.

In one embodiment, the solids from low temperature reducer include, reduced metal oxides, metal sulfides, ash, charcoal/biochar, and other solid-state debris resulting from the reduction process of the low temperature reducer. In various embodiments, these solids from the low temperature reducer are removed. Again, this is in direct contrast to prior art systems which recycled the metal oxides converting the reduced metal component to oxidized metal and oxidized metal to reduced metal over and over again in a closed loop.

Once the low temperature reducer is used to process the fuel provided, thereby creating solids and vapor, and reducing the metal oxides at operation 407, process flow proceeds to operation 309 where the output solids and vapor from the low temperature reducer are separated.

In one embodiment, the output solids and vapor from the low temperature reducer are separated at operation 309 using a solid/gas separator. In various embodiments, the solid/gas separator can be a cyclone, and/or a gravity-based system, including a long pipe, or a filter/screen, where the solids, such as reduced metal, ash and carbon biochar, and metal sulfides from the low temperature reduction process of the low temperature reducer are separated from the resultant vapor from the low temperature reduction process of the low temperature reducer.

Once separated at operation 409, the solids include unreacted fuel, now mostly unconverted carbon, ash, and biochar mixed with the now reduced metal oxides such as reduced Fe₃O₄, FeO, Fe, MnO, Mn₃O₄, Mn₂O₃, MnO₂, MnO₃, Mn, Mg, SnO, Sn, TiO, Ti₂O₃, Ti, WO₂, W₂O₃, W, NiO, Ni, Al₂O, AlO, Al, Cu₂O₃, CuO₂, CuO, Cu₂O, Cu, MoO₂, Ce₂O₃, Ce₃O₄, and Ce. In one embodiment, the reduced metal oxides in the solids separated from the solids at operation 309 and can be stored, sold, and/or sent to a separate, low temperature oxidation reactor. Consequently, in direct contrast to the prior art, decoupled CLR based syngas production process 300 includes open loop solids processing that is decoupled from decoupled CLR based syngas production process 400.

Consequently, using decoupled CLR based syngas production process 400, and in contrast to prior art teachings, oxidized metal can be created and/or obtained from processes performed at a different location or performed at a different time, i.e., oxidation of the oxidized metal need not to performed either on-site or in real time. One advantage of this configuration is that the oxidized metal can be lower temperature, in fact the oxidized metal can be provided at any temperature desired. This is in contrast to the prior systems where the oxidized metal is provided from within the system and in virtually real time and is therefore typically very high temperature, such as the 1,100 degrees Celsius.

In one embodiment, the vapor component, i.e., the gas from the low temperature reducer, is the base for the creation of syngas. Consequently, as discussed herein, in one embodiment, the vapor is provided to high temperature reformer for further processing.

As also discussed in more detail herein, in some embodiments, once the solids, such as reduced metal, ash and carbon biochar, and metal sulfides, are separated from the resultant vapor, magnets can be used to separate the reduced metal in the solids from the ash and carbon biochar in solids. As also discussed below, in some embodiments, once the reduced metal is separated from the ash and carbon biochar, magnets can also be used to separate reduced metal from metal sulfides.

Solid/gas separators are well known in the art. Consequently, a more detailed discussion of the operation of any particular solid/gas separator used at operation 309 is omitted here to avoid detracting from the invention. In various embodiments, the solid/gas separator can be any system capable of separating solids, such as reduced metal, ash and carbon biochar, and metal sulfides, from the resultant vapor of the low temperature reduction process of the low temperature reducer as discussed herein, and/or known in the art at the time of filing, and/or as developed/made available after the time of filing.

Once, the output solids and vapor from the low temperature reducer are separated at operation 409, process flow proceeds to operation 311 where the vapor output from the low temperature reducer is provided to a high temperature reformer.

As noted above, the vapor separated at operation 309, i.e., the gas from the low temperature reducer is the base for the creation of syngas. Consequently, at operation 311, the vapor is provided to high temperature reformer.

In one embodiment, once the vapor output from the low temperature reducer is provided to a high temperature reformer at operation 311, process flow proceeds to operation 313 where the vapor is transformed into syngas by the high temperature reformer of operation 311.

In some embodiments, at operation 313, in addition to the vapor, the high temperature reformer is also provided with other sources of oxygen and/or heat (not shown in FIG. 3). In various embodiments, the sources of oxygen can include steam, water, and/or elemental oxygen, or any other source of oxygen as discussed herein, and or as known in the art at the time of filing, and/or as developed/made available after the time of filing.

In one embodiment, at operation 313, the high temperature reformer is optionally provided supplementary heat from an external heat source, such as an electric heating element (not shown in FIG. 3), so that the temperature of the reduction reactions taking place in the high temperature reformer can be controlled separately from the temperature of low temperature reducer. In this way separate reaction temperature zones can be created for the low temperature reducer and high temperature reformer.

In one embodiment, at operation 313, the vapor continues through a 700° C. or hotter gasification zone of the high temperature reformer zone, further reacting with steam to produce syngas.

In one embodiment, at operation 313, as a result of the processing performed at the high temperature reformer, the vapor is transformed into syngas.

The operation of high temperature reformers is well known in the art. Consequently, a more detailed discussion of any particular embodiment of a high temperature reformer used at operation 313 is omitted here to avoid detracting from the invention. In various embodiments, the high temperature reformer can be any high temperature reformer capable of generating syngas from vapors provided from low temperature reducer reduction reactions of a low temperature reducer as discussed herein, and/or as known in the art at the time of filing, and/or as developed/made available after the time of filing.

In one embodiment, once the vapor output from the low temperature reducer is converted to syngas at operation 313, process flow proceeds to operation 315 where the syngas of operation 313 is treated to generate various products.

In one embodiment, at operation 315 the resultant syngas from the reactions taking place in high temperature reformer is provided to a gas treatment station where the syngas is used to produce various desired products. In various embodiments, the products can include, but are not limited to hydrogen, methanol, ethanol, synthetic fuels, waxes, acetic acid, formaldehyde, methyl acetate, acetic anhydride, ethylene, propylene, acrylic acid, alpha olefins, dimethyl ether, ammonia, urea, ammonium nitrate, acrylonitrile, electricity, various chemicals and the like.

The various methods and systems for converting syngas into various products at operation 315 are well known in the art. Consequently, a more detailed discussion of the operation of any specific method or process used to convert syngas into various products at operation 315 is omitted here to avoid detracting from the invention. In various embodiments, the methods and systems for converting syngas into various products of operation 315 can be any methods and systems for converting syngas into various products as discussed herein and/or as known in the art at the time of filing, and/or as developed/made available after the time of filing.

In one embodiment, once the resultant syngas from the reactions taking place in high temperature reformer is provided to a gas treatment station where the syngas is used to produce various desired products at operation 315, process flow proceeds to end 331 where process 300 is exited.

According to the disclosed embodiments, the metal oxidation and reduction processes are decoupled from the CLR based syngas production processes and systems; thereby avoiding the closed and coupled loop metal oxidation and reduction systems used with prior art CLR based syngas production processes and systems, and the high temperature complexities associated with prior art CLR based syngas production processes and systems.

Consequently, using the disclosed embodiments, and in direct contrast to prior art systems and teaching, the metal oxides are not reduced and oxidized in a continuous closed loop that is part of the overall CLR loop, i.e., the entire system need not be coupled and/or include a closed solids loop. Thus, using the disclosed embodiments, the same metal oxides need not circulate between metal oxidizing reactors and metal reducing reactors. Therefore, there is no requirement for the metal oxidizing reactors and metal reducing reactors to be connected; nor is there a requirement for a closed solids circulatory loop.

Consequently, using the disclosed decoupled CLR based syngas production processes and systems the complexities associated with the prior art systems and processes, the physical limitations of the metal-oxide oxygen carrier loop, and the barriers to widespread commercialization of CLR based syngas production processes and systems are removed. Thus, using the disclosed decoupled CLR based syngas production processes and systems, the full potential of CLR based syngas production processes and systems for providing sustainable syngas can be achieved.

In addition, since the disclosed decoupled CLR based syngas production processes and systems do not require that the metal oxides be reduced and oxidized in a continuous closed loop that is part of the overall CLR loop, several operational and safety issues associated with prior art processes and systems are avoided.

First, since using the disclosed decoupled CLR based syngas production processes and systems the oxidized metal can be provided from sources external to the CLR based syngas production processes and systems, the temperatures of the oxidized metal can be virtually any temperature desired. This is in contrast to the 1,100 degree Celsius temperatures of the oxidized metals produced in the prior art systems. Consequently, the safety issues for workers who must process and be generally around the oxidized metal and components are removed. In addition, using the disclosed decoupled CLR based syngas production processes and systems, the system components are not subject to the significant stresses and operational failure rates associated with high temperature oxidized metal. This potentially results in fewer worker injuries and system failures, as well as more desirable working conditions and less system down time using the disclosed decoupled CLR based syngas production processes and systems.

In addition, using the disclosed decoupled CLR based syngas production processes and systems, the temperatures of the oxidized metal used can be much lower. This avoids heat related failures and issues including, but not limited to deformation, sintering, plugging of transfer mechanisms and pipes, fouling, and erosion. This again increases system performance, decreases system down-time and results in more efficient conversion and collection of the resulting syngas.

In addition, by eliminating the closed and coupled loop systems taught in the prior art, the disclosed decoupled CLR based syngas production processes and systems avoid the time delays associated with prior art CLR based syngas production processes and systems that require that the same metals to be oxidized and provided to the metal reducing reactor where the syngas is created.

Further, using the disclosed decoupled CLR based syngas production processes and systems, the oxidized metal provided has a catalytic effect on the reduction reactions taking place in the low temperature reducer and provide for improved heat transfer due to metal oxide particle disbursement.

In addition, in various embodiments, sulfur species such as H₂S in the resultant syngas are reduced thru the formation and separation/removal of metal sulfides.

For these and numerous other reasons discussed herein, the disclosed decoupled CLR based syngas production processes and systems represent a significant improvement over the prior art methods and systems and provide a solution to the long-standing technical problem of providing methods and systems for producing syngas using CLR based syngas production processes and systems that do not suffer from the drawbacks associated with prior art closed and coupled loop metal oxidation and reduction systems.

In one embodiment, a synthesis gas production system includes oxidized metal, the oxidized metal having been oxidized in an uncoupled oxidation process outside the synthesis gas production system.

In one embodiment, the synthesis gas production system further includes a low temperature reducer. In one embodiment, the low temperature reducer receives fuel and the oxidized metal. In one embodiment, the low temperature reducer processes the fuel in the presence of the oxidized metal to produce solids and vapor as output components of the low temperature reducer.

In one embodiment, the synthesis gas production system further includes a solid/gas separator. In one embodiment, the solid/gas separator receives the solids and vapor output components of the low temperature reducer. In one embodiment, the solid/gas separator separates the solids output component of the low temperature reducer from the vapor output component of the low temperature reducer. In one embodiment, the synthesis gas production system further includes a high temperature reformer. In one embodiment, the high temperature reformer receives the vapor output component of the low temperature reducer from the solid/gas separator. In one embodiment, the high temperature reformer processes the vapor output component of the low temperature reducer to generate synthesis gas.

In one embodiment, at least part of the oxidized metal is an oxidized metal selected from the group of oxidized metals consisting of Fe₃O₄. Fe₂O₃, Mn₂O₇, Mn₃O₄, Mn₂O₃, MnO₂, MnO₃, MgO, SnO₂, TiO₂, Ti₂O₃, WO₃, WO₂, Ni₂O₃, NiO, Al₂O₃, AlO, Cu₂O₃, CuO₂, CuO, MoO₃, CeO₂, and Ce₃O₄.

In one embodiment, at least part of the fuel provided to the low temperature reducer is fuel selected from the group of fuels consisting of natural gas, landfill gas, petroleum gas, liquid petroleum, biomass, domestic and industrial refuse, refuse derived fuel, sewage, black liquor, coal, coke, animal waste, tar, oil shale, or any other source of carbon containing material.

In one embodiment, in addition to the metal oxides and fuel, one or more supplementary oxygen sources are provided to the low temperature reducer.

In one embodiment, external heat sources are used to provide heat to the low temperature reducer.

In one embodiment, the solid/gas separator is selected from the group of solid/gas separators consisting of a cyclone; a gravity based solid/gas separator; and a density based solid/gas separator.

In one embodiment, the synthesis gas production system further includes a solids separator. In one embodiment, the solids separator receives the solids output component of the low temperature reducer from the solid/gas separator and separates organic materials from metallic materials.

In one embodiment, the solids separator separates reduced metal oxides in the solids output component of the low temperature reducer from carbon, ash and biochar in the solids output component of the low temperature reducer.

In one embodiment, the solids separator is selected from the group of solids separators consisting of a magnetism based solid separator; a gravity based solid separator; and a density based solid separator.

In one embodiment, the synthesis gas production system further includes a gas treatment station. In one embodiment, the gas treatment station receives the synthesis gas from the high temperature reformer and processes the synthesis gas from the high temperature reformer to generate one or more desired products. In one embodiment, at least one of the desired products is selected from the group of products including hydrogen; methanol; ethanol; any Fischer-Tropsch fuels; electricity; and desired chemicals or chemical compounds.

In one embodiment, a synthesis gas production system includes oxidized metal, the oxidized metal having been oxidized in an uncoupled oxidation process outside the synthesis gas production system.

In one embodiment, the synthesis gas production system further includes a low temperature reducer. In one embodiment, the low temperature reducer receives fuel and the oxidized metal. In one embodiment, the low temperature reducer processes the fuel in the presence of the oxidized metal to produce solids and vapor as output components of the low temperature reducer.

In one embodiment, the synthesis gas production system further includes a solid/gas separator. In one embodiment, the solid/gas separator receives the solids and vapor output components of the low temperature reducer. In one embodiment, the solid/gas separator separates the solids output component of the low temperature reducer from the vapor output component of the low temperature reducer. In one embodiment, the synthesis gas production system further includes a high temperature reformer. In one embodiment, the high temperature reformer receives the vapor output component of the low temperature reducer from the solid/gas separator. In one embodiment, the high temperature reformer processes the vapor output component of the low temperature reducer to generate synthesis gas.

In one embodiment, the synthesis gas production system further includes a solids separator. In one embodiment, the solids separator receives the solids output component of the low temperature reducer from the solid/gas separator and separates organic materials from metallic materials.

In one embodiment, the synthesis gas production system further includes a sulfide separator. In one embodiment, the sulfide separator receives the metallic materials in the solids output component of the low temperature reducer from the solids separator. In one embodiment, the sulfide separator separates reduced metal from metal sulfides in the metallic materials in the solids output component of the low temperature reducer.

In one embodiment, at least part of the oxidized metal is an oxidized metal selected from the group of oxidized metals consisting of Fe₃O₄, Fe₂O₃, Mn₂O₇, Mn₃O₄, Mn₂O₃, MnO₂, MnO₃, MgO, SnO₂, TiO₂, Ti₂O₃, WO₃, WO₂, Ni₂O₃, NiO, Al₂O₃, AlO, Cu₂O₃, CuO₂, CuO, MoO₃ and CeO₂, Ce₃O₄.

In one embodiment, at least part of the fuel provided to the low temperature reducer is fuel selected from the group of fuels consisting of natural gas, landfill gas, petroleum gas, liquid petroleum, biomass, domestic and industrial refuse, refuse derived fuel, sewage, black liquor, coal, coke, animal waste, tar, oil shale, or any other source of carbon containing material.

In one embodiment, in addition to the metal oxides and fuel, one or more supplementary oxygen sources are provided to the low temperature reducer.

In one embodiment, external heat sources are used to provide heat to the low temperature reducer.

In one embodiment, the solid/gas separator is selected from the group of solid/gas separators consisting of a cyclone; a gravity based solid/gas separator; and a density based solid/gas separator.

In one embodiment, the synthesis gas production system further includes a solids separator. In one embodiment, the solids separator receives the solids output component of the low temperature reducer from the solid/gas separator and separates organic materials from metallic materials.

In one embodiment, the solids separator separates reduced metal oxides in the solids output component of the low temperature reducer from carbon, ash and biochar in the solids output component of the low temperature reducer.

In one embodiment, the solids separator is selected from the group of solids separators consisting of a magnetism based solid separator; a gravity based solid separator; and a density based solid separator.

In one embodiment, the synthesis gas production system further includes a gas treatment station. In one embodiment, the gas treatment station receives the synthesis gas from the high temperature reformer and processes the synthesis gas from the high temperature reformer to generate one or more desired products. In one embodiment, at least one of the desired products is selected from the group of products including hydrogen; methanol; ethanol; any Fischer-Tropsch fuels; electricity; and desired chemicals or chemical compounds.

In one embodiment, the sulfide separator is selected from the group of sulfide separators including a magnetism based sulfide separator; a gravity based sulfide separator; and a density based sulfide separator.

In one embodiment, the synthesis gas production system further includes a sulfur treatment station, In one embodiment, the sulfur treatment station receives the metal sulfides from the sulfide separator. In one embodiment, the sulfur treatment station removes sulfur from the metal sulfides to create sulfur and reduced metal.

In one embodiment, a synthesis gas production system includes oxidized metal, the oxidized metal having been oxidized in an uncoupled oxidation process outside the synthesis gas production system.

In one embodiment, the synthesis gas production system further includes a low temperature reducer. In one embodiment, the low temperature reducer receives fuel and the oxidized metal. In one embodiment, the low temperature reducer processes the fuel in the presence of the oxidized metal to produce solids and vapor as output components of the low temperature reducer.

In one embodiment, the synthesis gas production system further includes a solid/gas separator. In one embodiment, the solid/gas separator receives the solids and vapor output components of the low temperature reducer.

In one embodiment, the solid/gas separator separates the solids output component of the low temperature reducer from the vapor output component of the low temperature reducer. In one embodiment, the synthesis gas production system further includes a high temperature reformer. In one embodiment, the high temperature reformer receives the vapor output component of the low temperature reducer from the solid/gas separator. In one embodiment, the high temperature reformer processes the vapor output component of the low temperature reducer to generate synthesis gas.

In one embodiment, the synthesis gas production system further includes an oxidizer. In one embodiment, the oxidizer receives the reduced metal oxides in the solids output component of the low temperature reducer from the solids separator. In one embodiment, the oxidizer oxidizes the reduced metal oxides in the solids output component of the low temperature reducer to produce oxidized metal.

In one embodiment, the synthesis gas production system further includes a gas treatment station. In one embodiment, the gas treatment station receives the synthesis gas from the high temperature reformer and processes the synthesis gas from the high temperature reformer to generate one or more desired products. In one embodiment, at least one of the desired products is selected from the group of products consisting of: hydrogen; methanol; ethanol; any Fischer-Tropsch fuels; electricity; and desired chemicals or chemical compounds.

In one embodiment, method for producing synthesis gas includes: obtaining oxidized metal, the oxidized metal having been oxidized in an uncoupled oxidation process outside the method for producing synthesis gas; providing the oxidized metal to a low temperature reducer; providing fuel to the low temperature reducer; processing, in the low temperature reducer, the fuel in the presence of the oxidized metal to produce solids and vapor as output components of the low temperature reducer; providing the received solids and vapor output components of the low temperature reducer to a solid/gas separator, the solid/gas separator separating the solids output component of the low temperature reducer from the vapor output component of the low temperature reducer; providing the vapor output component of the low temperature reducer from the solid/gas separator to a high temperature reformer, the high temperature reformer processing the vapor output component of the low temperature reducer to generate synthesis gas; providing the solids output component of the low temperature reducer from the solid/gas separator to a solids separator, the solids separator receiving the solids output component of the low temperature reducer from the solid/gas separator and separating organic materials from metallic materials; and providing the metallic materials in the solids output component of the low temperature reducer from the solids separator to a sulfide separator, the sulfide separator receiving the metallic materials in the solids output component of the low temperature reducer from the solids separator, the sulfide separator separates reduced metal from metal sulfides in the metallic materials in the solids output component of the low temperature reducer.

In one embodiment, at least part of the oxidized metal is an oxidized metal selected from the group of oxidized metals consisting of Fe₃O₄, Fe₂O₃, Mn₂O₇, Mn₃O₄, Mn₂O₃, MnO₂, MnO₃, MgO, SnO₂, TiO₂, Ti₂O₃, WO₃, WO₂, Ni₂O₃, NiO, Al₂O₃, AlO, Cu₂O₃, CuO₂, CuO, MoO₃ and CeO₂, Ce₃O₄.

In one embodiment, at least part of the fuel provided to the low temperature reducer is fuel selected from the group of fuels consisting of natural gas, landfill gas, petroleum gas, liquid petroleum, biomass, domestic and industrial refuse, refuse derived fuel, sewage, black liquor, coal, coke, animal waste, tar, oil shale, or any other source of carbon containing material.

In one embodiment, in addition to the metal oxides and fuel, one or more supplementary oxygen sources are provided to the low temperature reducer.

In one embodiment, external heat sources are used to provide heat to the low temperature reducer.

In one embodiment, the solid/gas separator is selected from the group of solid/gas separators consisting of a cyclone; a gravity based solid/gas separator; and a density based solid/gas separator.

In one embodiment, the method for producing synthesis gas further includes providing the solids output component of the low temperature reducer from the solid/gas separator to a solids separator. In one embodiment, the solids separator receives the solids output component of the low temperature reducer from the solid/gas separator and separates organic materials from metallic materials.

In one embodiment, the solids separator separates reduced metal oxides in the solids output component of the low temperature reducer from carbon, ash and biochar in the solids output component of the low temperature reducer.

In one embodiment, the solids separator is selected from the group of solids separators consisting of a magnetism based solid separator; a gravity based solid separator; and a density based solid separator.

In one embodiment, the method for producing synthesis gas further includes providing the synthesis gas from the high temperature reformer and processes the synthesis gas from the high temperature reformer to a gas treatment station. In one embodiment, the gas treatment station receives the synthesis gas from the high temperature reformer and processing the synthesis gas from the high temperature reformer to generate one or more desired products. In one embodiment, at least one of the desired products is selected from the group of products including hydrogen; methanol; ethanol; any Fischer-Tropsch fuels; electricity; and desired chemicals or chemical compounds.

In one embodiment, a method for producing synthesis gas includes obtaining oxidized metal, the oxidized metal having been oxidized in an uncoupled oxidation process outside the method for producing synthesis gas; providing the oxidized metal to a low temperature reducer; providing fuel to the low temperature reducer; processing, in the low temperature reducer, the fuel in the presence of the oxidized metal to produce solids and vapor as output components of the low temperature reducer; providing the solids and vapor output components of the low temperature reducer to a solid/gas separator, the solid/gas separator separating the solids output component of the low temperature reducer from the vapor output component of the low temperature reducer; providing the vapor output component of the low temperature reducer from the solid/gas separator to a high temperature reformer, the high temperature reformer processing the vapor output component of the low temperature reducer to generate synthesis gas; providing the solids output component of the low temperature reducer from the solid/gas separator to a solids separator, the solids separator receiving the solids output component of the low temperature reducer from the solid/gas separator and separating organic materials from metallic materials; and providing the metallic materials in the solids output component of the low temperature reducer from the solids separator to a sulfide separator, the sulfide separator receiving the metallic materials in the solids output component of the low temperature reducer from the solids separator, the sulfide separator separating reduced metal from metal sulfides in the metallic materials in the solids output component of the low temperature reducer.

In one embodiment, a method for producing synthesis gas includes obtaining oxidized metal, the oxidized metal having been oxidized in an uncoupled oxidation process outside the method for producing synthesis gas; providing the oxidized metal to a low temperature reducer; providing fuel to the low temperature reducer; processing, in the low temperature reducer, the fuel in the presence of the oxidized metal to produce solids and vapor as output components of the low temperature reducer; providing the solids and vapor output components of the low temperature reducer to a solid/gas separator, the solid/gas separator separating the solids output component of the low temperature reducer from the vapor output component of the low temperature reducer; providing the vapor output component of the low temperature reducer from the solid/gas separator to a high temperature reformer, the high temperature reformer processing the vapor output component of the low temperature reducer to generate synthesis gas; providing the solids output component of the low temperature reducer from the solid/gas separator to a solids separator, the solids separator receiving the solids output component of the low temperature reducer from the solid/gas separator and separating organic materials from metallic materials; providing the metallic materials in the solids output component of the low temperature reducer from the solids separator to a sulfide separator, the sulfide separator receiving the metallic materials in the solids output component of the low temperature reducer from the solids separator, the sulfide separator separating reduced metal from metal sulfides in the metallic materials in the solids output component of the low temperature reducer; and providing the reduced metal oxides in the solids output component of the low temperature reducer from the solids separator to an oxidizer, the oxidizer receiving the reduced metal oxides in the solids output component of the low temperature reducer from the solids separator, the oxidizer oxidizing the reduced metal oxides in the solids output component of the low temperature reducer to produce oxidized metal.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

In addition, the operations shown in the figures, or as discussed herein, are identified using a particular nomenclature for ease of description and understanding, but other nomenclature is often used in the art to identify equivalent operations.

In addition, the operations and/or steps shown in the figures, or as discussed herein, are shown in a particular order for illustrative purposes only. The particular order of the operations and/or steps is not limiting nor is it intended to convey a required order.

Therefore, numerous variations, whether explicitly provided for by the specification or implied by the specification or not, may be implemented by one of skill in the art in view of this disclosure.

What is claimed is:

1. A synthesis gas production system comprising:
oxidized metal, the oxidized metal having been oxidized in an uncoupled oxidation process outside the synthesis gas production system;
a low temperature reducer, the low temperature reducer receiving fuel and the oxidized metal, the low temperature reducer processing the fuel in the presence of the oxidized metal to produce solids and vapor as output components of the low temperature reducer;
a solid/gas separator, the solid/gas separator receiving the solids and vapor output components of the low temperature reducer, the solid/gas separator separating the solids output component of the low temperature reducer from the vapor output component of the low temperature reducer; and
a high temperature reformer, the high temperature reformer receiving the vapor output component of the low temperature reducer from the solid/gas separator, the high temperature reformer processing the vapor output component of the low temperature reducer to generate synthesis gas.

2. The synthesis gas production system of claim 1 wherein at least part of the oxidized metal is an oxidized metal selected from the group of oxidized metals consisting of: Fe₃O₄, Fe₂O₃, Mn₂O₇, Mn₃O₄, Mn₂O₃, MnO₂, MnO₃, MgO, SnO₂, TiO₂, Ti₂O₃, WO₃, WO₂, Ni₂O₃, NiO, Al₂O₃, AlO, Cu₂O₃, CuO₂, CuO, MoO₃ and CeO₂, Ce₃O₄.

3. The synthesis gas production system of claim 1 wherein at least part of the fuel provided to the low temperature reducer is fuel selected from the group of fuels consisting of: natural gas, landfill gas, petroleum gas, liquid petroleum, biomass, domestic and industrial refuse, refuse derived fuel, sewage, black liquor, coal, coke, animal waste, tar, and oil shale.

4. The synthesis gas production system of claim 1 wherein in addition to the metal oxides and fuel, one or more supplementary oxygen sources are provided to the low temperature reducer.

5. The synthesis gas production system of claim 1 wherein external heat sources are used to provide heat to the low temperature reducer.

6. The synthesis gas production system of claim 1 wherein the solid/gas separator is selected from the group of solid/gas separators consisting of:
a cyclone;
gravity based solid/gas separators;
density based solid/gas separators; and
mechanical based solid/gas separators.

7. The synthesis gas production system of claim 1 further comprising a solids separator, the solids separator receiving the solids output component of the low temperature reducer from the solid/gas separator and separating organic materials from metallic materials.

8. The synthesis gas production system of claim 7 wherein the solids separator separates reduced metal oxides in the solids output component of the low temperature reducer from carbon, ash and biochar in the solids output component of the low temperature reducer.

9. The synthesis gas production system of claim 7 wherein the solids separator is selected from the group of solids separators consisting of:
magnetism based solid separators;
gravity based solid separators; and
density based solid separators.

10. The synthesis gas production system of claim 1 further comprising:
a gas treatment station, the gas treatment station receiving the synthesis gas from the high temperature reformer and processing the synthesis gas from the high temperature reformer to generate one or more desired products.

11. The synthesis gas production system of claim 10 wherein at least one of the desired products is selected from the group of products consisting of:
hydrogen;
methanol;
ethanol;
Fischer-Tropsch fuels;
electricity; and
desired chemicals or chemical compounds.

12. A synthesis gas production system comprising:
oxidized metal, the oxidized metal having been oxidized in an uncoupled oxidation process outside the synthesis gas production system;
a low temperature reducer, the low temperature reducer receiving fuel and the oxidized metal, the low temperature reducer processing the fuel in the presence of the oxidized metal to produce solids and vapor as output components of the low temperature reducer;
a solid/gas separator, the solid/gas separator receiving the solids and vapor output components of the low temperature reducer, the solid/gas separator separating the solids output component of the low temperature reducer from the vapor output component of the low temperature reducer;
a high temperature reformer, the high temperature reformer receiving the vapor output component of the low temperature reducer from the solid/gas separator, the high temperature reformer processing the vapor output component of the low temperature reducer to generate synthesis gas;
a solids separator, the solids separator receiving the solids output component of the low temperature reducer from the solid/gas separator and separating organic materials from metallic materials; and
a sulfide separator, the sulfide separator receiving the metallic materials in the solids output component of the low temperature reducer from the solids separator, the sulfide separator separating reduced metal from metal sulfides in the metallic materials in the solids output component of the low temperature reducer.

13. The synthesis gas production system of claim 12 wherein the solids separator is selected from the group of solids separators consisting of:
magnetism based solid separators;
gravity based solid separators; and
density based solid separators.

14. The synthesis gas production system of claim 12 wherein the sulfide separator is selected from the group of sulfide separator consisting of:
magnetism based sulfide separators;
gravity based sulfide separators; and
density based sulfide separators.

15. The synthesis gas production system of claim 12 further comprising:
a sulfur treatment station, the sulfur treatment station receiving the metal sulfides from the sulfide separator, the sulfur treatment station removing sulfur from the metal sulfides to create sulfur and reduced metal.

16. The synthesis gas production system of claim 12 further comprising:
a gas treatment station, the gas treatment station receiving the synthesis gas from the high temperature reformer and processing the synthesis gas from the high temperature reformer to generate one or more desired products.

17. The synthesis gas production system of claim 16 wherein at least one of the desired products is selected from the group of products consisting of:
hydrogen;
methanol;
ethanol;
Fischer-Tropsch fuels;
electricity; and
desired chemicals or chemical compounds.

18. A synthesis gas production system comprising:
oxidized metal, the oxidized metal having been oxidized in an uncoupled oxidation process outside the synthesis gas production system;
a low temperature reducer, the low temperature reducer receiving fuel and the oxidized metal, the low temperature reducer processing the fuel in the presence of the oxidized metal to produce solids and vapor as output components of the low temperature reducer;
a solid/gas separator, the solid/gas separator receiving the solids and vapor output components of the low temperature reducer, the solid/gas separator separating the solids output component of the low temperature reducer from the vapor output component of the low temperature reducer;
a high temperature reformer, the high temperature reformer receiving the vapor output component of the low temperature reducer from the solid/gas separator, the high temperature reformer processing the vapor output component of the low temperature reducer to generate synthesis gas;
a solids separator, the solids separator receiving the solids output component of the low temperature reducer from the solid/gas separator and separating organic materials from metallic materials, the solids separator separating reduced metal oxides in the solids output component of the low temperature reducer from carbon, ash and biochar in the solids output component of the low temperature reducer; and
an oxidizer, the oxidizer receiving the reduced metal oxides in the solids output component of the low temperature reducer from the solids separator, the oxidizer oxidizing the reduced metal oxides in the solids output component of the low temperature reducer to produce oxidized metal.

19. The synthesis gas production system of claim 18 further comprising:
a gas treatment station, the gas treatment station receiving the synthesis gas from the high temperature reformer and processing the synthesis gas from the high temperature reformer to generate one or more desired products.

20. The synthesis gas production system of claim 19 wherein at least one of the desired products is selected from the group of products consisting of:
hydrogen;
methanol;
ethanol;
Fischer-Tropsch fuels;
electricity; and
desired chemicals or chemical compounds.
